(19) United States
(12) Patent Application Publication
(10) Pub. No.: US 2026/0197289 A1
(43) Pub. Date: Jul. 9, 2026

(54) MESSAGING HISTORY USING DIRECTED PROPERTY GRAPHS

(71) Applicant: Infosys Limited, Bangalore (IN)

(72) Inventors: Chitra THEAGARAJAN, Bengaluru (IN); Steven SCHILDERS, Indianapolis, IN (US)

(73) Assignee: Infosys Limited, Bangalore, KA (IN)

(21) Appl. No.: 19/078,844

(22) Filed: Mar. 13, 2025

(30) Foreign Application Priority Data
Jan. 7, 2025 (IN) 202541001499

(51) Int. Cl. H04L 51/216

(52) U.S. Cl. CPC H04L 51/216

(57) ABSTRACT

The present disclosure facilitates optimized storage of historical data. A graph is generated using various messages. For each message, a message node is instantiated in the graph. In a message-driven architecture, processing of a message leads to the generation of a data node in the graph. The data node represents an output associated with the message processing. In response to the data node generation, another message node is instantiated in the graph. The other message node represents a message that is indicative of the generation of the data node and comprises data and transactional information associated with the data node. Further, a history node is created linking the data node and the two message nodes to indicate that the data node is an output associated with the message processing and the newly generated message node stores a change associated with the data node.

### FIELD OF THE DISCLOSURE

Various embodiments of the present disclosure relate generally to directed property graphs. More specifically, various embodiments of the present disclosure relate to messaging history using directed property graphs.

### BACKGROUND

Data-driven industries such as business, healthcare, finance, robotics, or the like, involve huge amounts of data processing. In these sectors, data may be stored and modified for facilitating the execution of one or more tasks. Modification of the data may potentially lead to overwriting of the previous data records, making them inaccessible. However, previous data records (also referred to as “historical data”) may be essential for such data-driven industries. The historical data may be utilized for analyzing past trends, making informed decisions, predicting future outcomes, or the like. For example, in healthcare, historical data may be required to track patient's medical history to make informed, timely decisions in case of critical health conditions. Therefore, the unavailability of historical data may hinder the generation of real-time insights and hinder low-latency decision-making. Such delays may be fatal in time-critical tasks.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating messaging history using directed property graphs are provided substantially as shown in, and described in connection with, at least one of the figures.

In an embodiment of the present disclosure, a system is disclosed. The system includes processing circuitry configured to generate a graph based on a plurality of messages. To generate the graph, the processing circuitry is further configured to instantiate a first message node that represents a first message of the plurality of messages. The processing circuitry is further configured to generate a first data node based on the processing of the first message. Further, the processing circuitry instantiates a second message node that represents a second message of the plurality of messages. The second message is indicative of the generation of the first data node and comprises data and transactional information associated with the first data node. The processing circuitry is further configured to create a first history node that links the first message node, the second message node, and the first data node. The generated graph facilitates query response generation.

In some embodiments, the first message corresponds to a command, and the first data node is generated based on an execution of the command.

In some embodiments, the first message corresponds to an event, and the first data node is generated based on a handling of the event.

In some embodiments, the second message corresponds to an event header.

In some embodiments, the processing circuitry is further configured to determine a set of attributes for each of the first message node, the first data node, the second message node, and the first history node, and associate the determined set of attributes as node properties thereof.

In some embodiments, the node properties of each of the first message node and the second message node comprise at least one of a group consisting of a message identifier or a message type. The node properties of the first data node comprise at least one of a group consisting of a data node identifier or a data node version number. The node properties of the first history node comprise at least one of a group consisting of a history node identifier, a previous data node version number, or a next data node version number.

In some embodiments, a response to a query is generated based on at least one of a group consisting of (i) the first message node, (ii) node properties of the first message node, (iii) the first history node, (iv) node properties of the first history node, (v) the first data node, (vi) node properties of the first data node, (vii) the second message node, or (viii) node properties of the second message node.

In some embodiments, the processing circuitry is further configured to create a first history-message edge between the first history node and the first message node. The first history-message edge indicates that the first message represented by the first message node is a cause for the generation of the first data node. The processing circuitry is further configured to create a first history-data edge between the first history node and the first data node. The first history-data edge indicates that the first data node is an output associated with the processing of the first message. The processing circuitry is further configured to create a second history-message edge between the first history node and the second message node. The second history-message edge indicates a change associated with the first data node.

In some embodiments, for each of the first history-message edge, the first history-data edge, and the second history-message edge, the processing circuitry is further configured to determine a type attribute and associate the type attribute as edge properties thereof. The type attribute of the first history-message edge, the first history-data edge, and the second history-message edge indicates cause, output, and change, respectively.

In some embodiments, for each of the first history-message edge, the first history-data edge, and the second history-message edge, the processing circuitry is further configured to determine a set of edge attributes and associate the determined set of edge attributes as edge properties thereof.

In some embodiments, the set of edge attributes of the first history-message edge comprises (i) at least one attribute associated as node properties of the first history node and (ii) at least one attribute associated as node properties of the first message node. The set of edge attributes of the first history-data edge comprises (i) at least one attribute associated as the node properties of the first history node and (ii) at least one attribute associated as node properties of the first data node. The set of edge attributes of the second history-message edge comprises (i) at least one attribute associated as the node properties of the first history node and (ii) at least one attribute associated as node properties of the second message node.

In some embodiments, a response to a query is generated based on at least one of a group consisting of (i) the first history-message edge, (ii) edge properties of the first history-message edge, (iii) the first history-data edge, (iv) edge properties of the first history-data edge, (v) the second history-message edge, or (vi) edge properties of the second history-message edge.

In some embodiments, the processing circuitry is further configured to delete the first data node from the graph.

In some embodiments, to generate the graph, the processing circuitry is further configured to instantiate a third message node that represents a third message of the plurality of messages. The processing circuitry is further configured to identify, based on the third message, the first data node in the graph. The processing circuitry is further configured to generate a second data node based on the processing of the third message and the first data node. The processing circuitry is further configured to instantiate a fourth message node that represents a fourth message of the plurality of messages. The fourth message is indicative of the generation of the second data node and comprises data and transactional information associated with the second data node. The processing circuitry is further configured to create a second history node that links the third message node, the fourth message node, and the second data node.

In some embodiments, the first data node corresponds to a previous version of the second data node such that the first data node is modified based on the processing of the third message to generate the second data node.

In some embodiments, the processing circuitry is further configured to create a history edge between the second history node and the first history node. The processing circuitry is further configured to determine, for the history edge, a set of edge attributes that is indicative of an association between the second history node and the first history node. The determined set of attributes comprises at least one of a group consisting of a history node identifier, a previous data node version number, or a next data node version number. Further, the processing circuitry is configured to associate the set of edge attributes as edge properties of the history edge.

In some embodiments, a response to a query is generated based on at least one of a group consisting of (i) the third message node, (ii) node properties of the third message node, (iii) the second history node, (iv) node properties of the second history node, (v) the second data node, (vi) node properties of the second data node, (vii) the fourth message node, (viii) node properties of the fourth message node, (ix) the history edge, or (x) the edge properties of the history edge.

In some embodiments, the processing circuitry is further configured to delete at least one of the first data node or the second data node from the graph.

In some embodiments, the processing circuitry is further configured to delete the first history node from the graph based on at least one of a history depth or a history retention period associated with the graph. The history depth indicates a maximum number of history nodes associated with one message trail. The history retention period indicates a maximum time duration for which each history node is retained in the graph.

In some embodiments, the processing circuitry is further configured to identify, in the graph, a third data node that corresponds to a previous version of the first data node. The third data node is modified based on the processing of the first message to generate the first data node.

In some embodiments, the processing circuitry is further configured to receive a query that comprises a reference value. The processing circuitry is further configured to identify, in the graph, at least one history node having a data value that is associated with the reference value. The processing circuitry is further configured to identify one or more edges associated with the identified history node. Further, the processing circuitry is configured to generate a response to the query based on the identified history node and the identified one or more edges.

In some embodiments, the processing circuitry is further configured to identify one or more nodes linked to the identified one or more edges, respectively. An identified node, of the identified one or more nodes, corresponds to one of a group consisting of a message node, another history node, and a data node. The response is generated further based on the identified one or more nodes.

In some embodiments, the processing circuitry is further configured to receive a query that comprises a reference value. The processing circuitry is further configured to identify, in the graph, at least one edge having an edge property that is associated with the reference value. Further, the processing circuitry is configured to generate a response to the query based on the identified at least one edge.

In some embodiments, the processing circuitry is further configured to receive a query that comprises a reference value. The processing circuitry is further configured to identify, in the graph, at least one history node having a data value that is associated with the reference value. Further, the processing circuitry is configured to determine that a data node associated with the identified history node is absent in the graph. The processing circuitry is further configured to identify, in the graph, based on the identified history node, a message node that represents a message comprising data and transactional information associated with the data node. Further, the processing circuitry is configured to recreate, based on the identified message node, the data node associated with the identified history node. The processing circuitry is further configured to generate a response to the query based on the recreated data node.

In some embodiments, the processing circuitry is further configured to receive a query that comprises a reference value. Further, the processing circuitry is configured to identify, in the graph, at least one history node having a data value that is associated with the reference value. The processing circuitry is further configured to determine that a data node associated with the identified history node is absent in the graph. Further, the processing circuitry is configured to determine, based on node properties of the identified history node, that the data node has a previous version. The processing circuitry is further configured to identify, in the graph, based on the identified history node, another history node associated with the previous version of the data node. Further, the processing circuitry is configured to identify, in the graph, based on the identified other history node, a message node that represents a message comprising data and transactional information associated with the previous version of the data node. The processing circuitry is further configured to recreate, based on the identified message node, the previous version of the data node. The processing circuitry is further configured to identify, in the graph, based on the identified history node, another message node that represents another message comprising data and transactional information associated with the data node. Further, the processing circuitry is configured to recreate, based on the identified other message node and the previous version of the data node, the data node associated with the identified history node. The previous version of the data node is modified based on the other message to recreate the data node. The processing circuitry is further configured to generate a response to the query based on the recreated data node.

In some embodiments, the system further comprises a storage element. The processing circuitry is coupled to the storage element, and configured to store the graph in the storage element.

In some embodiments, the graph corresponds to a directed property graph.

In some embodiments, a method is disclosed. The method comprises generating, by processing circuitry, a graph based on a plurality of messages. The step of generating the graph further comprises instantiating, by the processing circuitry, a first message node that represents a first message of the plurality of messages. The step of generating the graph further comprises generating, by the processing circuitry, a first data node based on processing of the first message. The step of generating the graph further comprises instantiating, by the processing circuitry, a second message node that represents a second message of the plurality of messages. The second message is indicative of the generation of the first data node and comprises data and transactional information associated with the first data node. The step of generating the graph further comprises creating, by the processing circuitry, a first history node that links the first message node, the second message node, and the first data node. The generated graph facilitates query response generation.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a block diagram that illustrates a system environment for messaging history using directed property graphs, consistent with disclosed embodiments of the present disclosure;

FIG. 2 is a block diagram that illustrates composition of a message, consistent with disclosed embodiments of the present disclosure;

FIG. 3 is a graph illustrating association between message and attribute nodes, consistent with disclosed embodiments of the present disclosure;

FIG. 4 is a graph illustrating a compact view of correlation between message nodes, consistent with disclosed embodiments of the present disclosure;

FIG. 5A is a graph illustrating the creation, maintenance, and utilization of messaging history, consistent with disclosed embodiments of the present disclosure;

FIG. 5B illustrates snapshotting in the graph of FIG. 5A, consistent with disclosed embodiments of the present disclosure;

FIG. 6 illustrates an example computing system for carrying out the methods of the present disclosure, consistent with disclosed embodiments of the present disclosure; and

FIGS. 7A and 7B, collectively, represents a flowchart that illustrates a method for facilitating messaging history using directed property graphs, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

In data-driven industries, data may be continuously generated and operated upon, creating historical records that need to be stored for various applications, such as trend analysis, healthcare monitoring, or the like. Conventionally, to ensure the availability of previous versions of the data (e.g., historical data), the historical data may be stored in various databases. The stored data can be utilized for various use cases by way of query processing. Efficient retrieval of this data from the database may play an important role in query processing. Therefore, the structure of the data storage may directly influence the query performance. That is to say, suboptimal data storage structure can lead to significant inefficiencies, such as increased query latency, higher computational costs, or the like. Such delays or inefficiencies can hinder time-sensitive tasks and may negatively affect the overall performance. Further, a data-driven industry may process significant amounts of data, and maintaining all the historical data records may be costly in terms of memory utilization.

The present disclosure provides a different approach to facilitate optimized storage of historical data. The present disclosure discloses a graph (e.g., a directed property graph) generated using various messages associated with a real-time system. For each message, a message node may be instantiated in the graph. In a message-driven architecture, data modification is governed by way of messages. Thus, the processing of a message may lead to the generation of a data node in the graph. The data node may represent an output associated with the message processing. In response to the creation of the data node, another message node may be instantiated in the graph. The other message node may represent another message that may be indicative of the generation of the data node and comprise data and transactional information associated with the data node. Further, a history node may be created linking the data node and the two message nodes. The history node links the data node and the two message nodes to indicate that the data node is an output associated with the message processing and the newly generated message node stores a change associated with the data node. The history node may be coupled to the data node and the two message nodes by way of corresponding edges. Each node and edge of the graph may have various attributes associated as properties thereof.

When an update of the data node is required, an update message (e.g., a command or an event message) may be processed and the updated data node, two message nodes, and another history node may be created in a similar manner as described above. The newly generated data node may be referred to as an updated version of the initial data node. Further, the two history nodes may be coupled by way of a history edge.

Such a graph may facilitate optimized query processing. In such a graph, the query processing may start from a history node or a history edge. In both cases, the node properties of the history node and/or the edge properties of the history edge can be utilized to generate a response to the query. The graph structure may allow the deletion of data nodes from the graph based on a lapse of a predetermined time period after the query response generation. In such cases, when the deleted data nodes are required for query processing, the history nodes and the message nodes present in the graph may be utilized to recreate the deleted data nodes. Thus, the data nodes may not be required to be consistently persisted in the graph, resulting in optimized memory utilization. Additionally, in some scenarios, the earliest historical data may not be required for the generation of real-time responses. Therefore, the graph structure may aid in efficient data retrieval, improved resource utilization, and faster query processing. Notably, the generation of the history edge may allow faster traversal to the previous history nodes, further aiding in faster query processing. It is appreciated that the human mind is not equipped to conceptualize an optimized creation, maintenance, and recreation of historical data based on messages in the directed property graph, given the digital interconnectedness of the creation, maintenance, and recreation.

### Figure Description

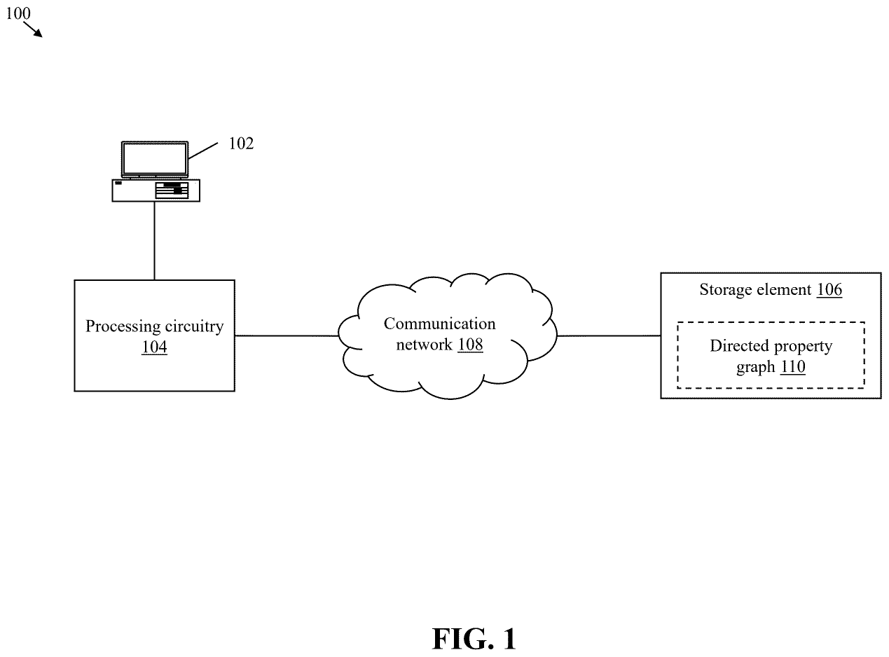

FIG. 1 is a block diagram that illustrates a system environment 100 for messaging history using directed property graphs, consistent with disclosed embodiments of the present disclosure. In today's fast-paced world, real-world problems (e.g., fraud detection, healthcare, traffic congestion, or the like) require historical data to generate real-time analytics for quick and efficient decision-making. Such an approach may require optimization at every stage of problem-solving. A problem may be solved by gaining real-time analytics and making decisions thereupon. Typically, a real-world problem may be distributed across different services, with each component of the problem being handled by a specific service. These services may be referred to as microservices. A microservice may be specifically designed to execute a particular task.

Upon execution of the task, the microservice may generate a message that may include transactional information associated with the task. These messages may be stored in a database for various purposes (e.g., real-time analytics for decision-making). Additionally, in a message-driven architecture, data modification is governed by way of messages (e.g., processing of messages). Modification of the data may potentially lead to overwriting of the previous data records, making them inaccessible. The previous data records (also referred to as “historical data”) may be utilized for analyzing past trends, making informed decisions, predicting future outcomes, or the like. Therefore, the maintenance of historical data may be important for real-time analytics and decision-making.

Conventionally, to ensure the availability of the historical data, the historical data may be stored in various databases. The stored data can be utilized for various use cases by way of query processing. Efficient retrieval of this data from the database may play an important role in query processing. Therefore, the structure of the data storage may directly influence the query performance. That is to say, suboptimal data storage structure can lead to significant inefficiencies, such as increased query latency, higher computational costs, higher storage requirements, or the like. Such delays or inefficiencies can hinder time-sensitive tasks and may negatively affect the overall performance. Further, a data-driven industry may process significant amounts of data, and maintaining all the historical data records may be costly in terms of memory utilization.

The present disclosure provides a solution to implement optimized data storage, faster query processing, and efficient real-time analysis by storing historical data and messages comprising data and transactional information associated with the historical data in directed property graphs. A directed property graph is a graph data model consisting of nodes, edges, and properties, where edges have direction and both nodes and edges can store key-value pairs, allowing for complex data representation and efficient querying. Referring to FIG. 1, the system environment 100 may include a real-time system 102, processing circuitry 104, a storage element 106, and a communication network 108. The processing circuitry 104 is configured to access the storage element 106 via the communication network 108.

The real-time system 102 may represent a distributed platform that encompasses various microservices for the resolution of real-world problems. Each microservice handling a particular task associated therewith may generate/publish a message at the end of the task execution. The published message may correspond to an output of the microservice. Other microservices associated with the real-time system 102 may further subscribe to and process the published message. Processing of the message may result in data modification. As the new data is generated, the previous version of the data (e.g., the historical data) may need to be preserved. The historical data may be utilized by various microservices for the execution of various tasks.

The processing circuitry 104 may include suitable logic, circuitry, interfaces, and/or code, executable by the circuitry, that may be configured to perform optimized query processing. The processing circuitry 104 may be configured to generate (e.g., derive) a directed property graph 110 based on the messages associated with the real-time system 102, and store the directed property graph 110 in the storage element 106. Examples of the storage element 106 may include, but are not limited to, a random-access memory (RAM), a read-only memory (ROM), a removable storage drive, a hard disk drive (HDD), a flash memory, a solid-state memory, or the like.

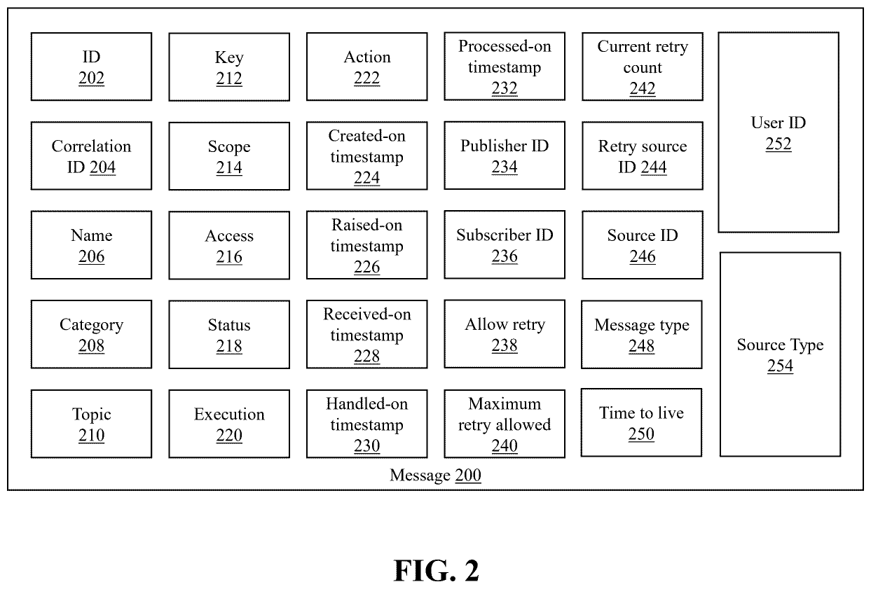

Each message may be associated with various attributes that may correspond to transactional information associated with the real-time system 102. The transactional information may define the composition of the message. Various attributes associated with the message may correspond to an identifier (ID), a correlation ID, a user ID, a name, a category, a topic, a key, a scope, an access, a status, an execution, an action, a message type, a created-on timestamp, a raised-on timestamp, a received-on timestamp, a handled-on timestamp, a processed-on timestamp, a publisher ID, a subscriber ID, an allow retry, a maximum retry allowed, a retry count, a retry source ID, a source ID, and a source type. The composition of the message is described in detail in conjunction with FIG. 2.

### Generation of the Directed Property Graph 110

To generate the directed property graph 110, the processing circuitry 104 may execute various operations. For example, the processing circuitry 104 may be configured to instantiate a message node representing a message associated with the real-time system 102. Based on the processing of the message, the processing circuitry 104 may be configured to generate a data node in the directed property graph 110. In an embodiment, the message may correspond to a command. In such a scenario, the data node may be generated based on the execution of the command. In another embodiment, the message may correspond to an event. In such a scenario, the data node may be generated based on the handling of the event. The data node may represent an output associated with the message processing.

In response to the generation of the data node, the processing circuitry 104 may be further configured to instantiate another message node representing an event header message that is indicative of the generation of the data node and that comprises data and transactional information associated with the data node. The processing circuitry 104 may be further configured to create a history node linking the data node and the two message nodes. The history node may link the data node and the two message nodes to indicate that the data node is an output associated with the message processing and the newly generated message node stores a change associated with the data node.

The processing circuitry 104 may be further configured to determine one or more attributes for each of the message nodes, the data node, and the history node, and associate the determined one or more attributes as node properties thereof. Further, the processing circuitry 104 may be configured to create two history-message edges coupling the history node to the two message nodes and a history-data edge coupling the history node to the data node. The processing circuitry 104 may be further configured to determine one or more edge attributes for each edge, and associate the determined edge attributes as edge properties thereof.

When an update of the data node is required, the processing circuitry 104 may be configured to receive an update message (e.g., a command or an event message). The processing circuitry 104 may process the update message and generate the updated data node, two message nodes, and another history node in a similar manner as described above. The newly generated data node may be referred to as an updated version of the initial data node. In other words, the initial data node corresponds to a previous version of the newly generated data node such that the initial data node is modified based on the processing of the update message to generate the new data node. Further, the two history nodes may be coupled by way of a history edge. The processing circuitry 104 may be further configured to determine one or more edge attributes for the history edge, and associate the determined edge attributes as edge properties thereof.

Such a structure of the directed property graph 110 may facilitate optimized memory utilization and efficient query processing. In an embodiment, the processing circuitry 104 may be configured to receive a query. The query processing may start from a history node or a history edge. In both cases, the node properties of the history node and/or the edge properties of the history edge can be utilized to generate a response to the query. Notably, the generation of the history edge may allow faster traversal to the previous history nodes, aiding in faster query processing.

The processing circuitry 104 may be further configured to delete one or more data nodes from the directed property graph 110. In an embodiment, the data nodes may be deleted based on a lapse of a predetermined time period after the query response generation. In another embodiment, the data nodes may be deleted based on a lapse of a predetermined time period after the generation thereof. In such cases, when the deleted data nodes are required for query processing, the processing circuitry 104 may be configured to recreate the deleted data nodes using the history nodes and the message nodes present in the directed property graph 110. Thus, the need to consistently persist the data nodes in the directed property graph 110 may be eliminated, resulting in optimized memory utilization. Additionally, in some scenarios, the earliest historical data may not be required for the generation of real-time responses. In the present disclosure, the processing circuitry 104 may be configured to delete the history nodes from the directed property graph 110 based on at least one of a history depth or a history retention period associated with the directed property graph 110. The history depth may indicate a maximum number of history nodes associated with one message trail, and the history retention period may indicate a maximum time duration for which each history node is retained in the directed property graph 110. The graph structure of the present disclosure may thus aid in efficient data retrieval, improved resource utilization, and faster query processing.

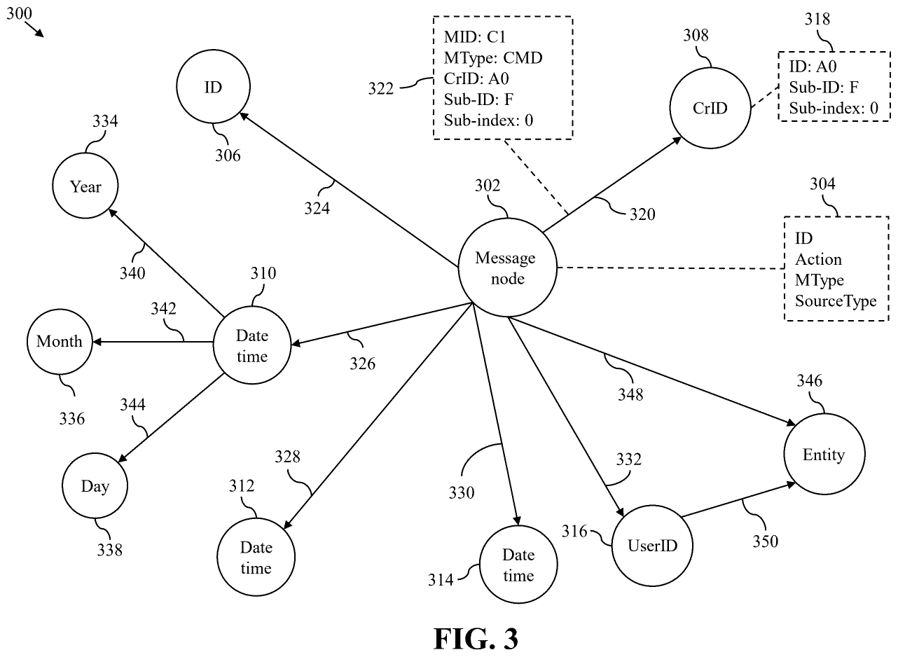

The structure of the directed property graph 110 is explained in detail in conjunction with FIGS. 3, 4, 5A, and 5B.

The processing circuitry 104 may be implemented by one or more processors, such as, but not limited to, an application-specific integrated circuit (ASIC) processor, a reduced instruction set computer (RISC) processor, a complex instruction set computer (CISC) processor, and a field programmable gate array (FPGA) processor. The one or more processors may also correspond to central processing units (CPUs), graphics processing units (GPUs), neural processing units (NPUs), digital signal processors (DSPs), or the like. It will be apparent to a person of ordinary skill in the art that the processing circuitry 104 may be compatible with multiple operating systems. The processing circuitry 104 may further include one or more components (for example, a parser, a loader, or the like) that may be configured to execute one or more operations to be executed by the processing circuitry 104.

The communication network 108 is a medium through which instructions and data are transmitted between the processing circuitry 104 and the storage element 106. Examples of the communication network 108 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, microwave communication, and a combination thereof. Examples of the communication network 108 may further include a Narrow Band-Internet of Things (NB-IoT) network, a 5G network, a 4G network, a long-range (LoRa) wireless technology network, a ZigBee network, an Ipv6 Low-power Wireless Personal Area Network (6LowPAN), or the like. Various entities (such as the processing circuitry 104 and the storage element 106) in the system environment 100 may be coupled to the communication network 108 in accordance with various wired and wireless communication protocols, such as Transmission Control Protocol and Internet Protocol (TCP/IP), User Datagram Protocol (UDP), Long Term Evolution (LTE) communication protocols, or any combination thereof.

Although the present disclosure describes the generation and utilization of a directed property graph (e.g., the directed property graph 110), the scope of the present disclosure is not limited to it. In numerous embodiments, other types of graphs, such as undirected graphs, weighted graphs, bipartite graphs, or the like, may be utilized without deviating from the scope of the present disclosure.

The scope of the present disclosure is not limited to a standalone realization of the storage element 106, as described herein. In numerous embodiments, the storage element 106 can be realized in the form of a database server or a cloud storage working in conjunction with the processing circuitry 104, without departing from the scope of the present disclosure.

FIG. 2 is a block diagram that illustrates composition of a message 200, consistent with disclosed embodiments of the present disclosure. The message 200 may correspond to one of a command-type message, a query-type message, or an event-type message. The message 200 may be associated with the real-time system 102. The message 200 may include data and transactional information. Data included in the composition of the message 200 may refer to the message payload. In other words, the data in the composition of the message 200 refers to a statement, an instruction, a message, a command, a query, or the like, that is being communicated via the message 200.

Referring to FIG. 2, the composition of the message 200 includes a plurality of attributes that form the transactional information associated with the message 200. The plurality of attributes may include an ID 202, a correlation ID 204, a name 206, a category 208, a topic 210, a key 212, a scope 214, an access 216, a status 218, an execution 220, an action 222, a created-on timestamp 224, a raised-on timestamp 226, a received-on timestamp 228, a handled-on timestamp 230, a processed-on timestamp 232, a publisher ID 234, a subscriber ID 236, an allow retry 238, a maximum retry allowed 240, a current retry count 242, a retry source ID 244, a source ID 246, a message type 248, a time to live 250, a user ID 252, and a source type 254. Though the data associated with the message 200 is not shown in FIG. 2, it will be apparent to a person skilled in the art that the composition of the message 200 includes the data to be communicated by the message 200.

The ID 202 is a unique ID associated with the message 200 and may be used by the processing circuitry 104 to identify the message 200.

The correlation ID 204 is an ID that is shared among messages that are related. The correlation ID 204 may be used to join and correlate one or more messages in a transaction flow such as a command-to-event, a query-to-event, or the like. Each sub-message (e.g., child message) of a compound message (e.g., parent message) may include a hierarchical correlation ID. Further, sub-messages at the same level of hierarchy may have identical data values for the correlation ID 204. Sub-messages at each subsequent hierarchical level may further include data values of the correlation ID 204 of sub-messages at previous hierarchical levels. Each sub-message may also include a root ID that is associated with the parent message.

The name 206 is a human-understandable descriptor of the message 200 and is solely included for the ease of understanding of users associated with the real-time system 102.

The category 208 is a human-understandable descriptor of a domain or criterion of the message. For example, a data value of the category 208 of the message 200 may be an order management message.

The topic 210 is a human-understandable descriptor of a topic/domain/subject/agenda associated with which the message 200 has been published. Notably, the topic 210 allows the grouping of multiple messages irrespective of their category. Each message may be associated with a single data value of the topic 210. Notably, multiple messages may be associated with the same data value of the topic 210. Each data value of the topic 210 may have one or more subscribers (for example, one or more microservices). The subscriber may handle the message 200 associated with a topic. Each data value of the topic 210 may be published/scheduled for processing using a specific pipeline of a messaging bus (shown in FIG. 10).

The key 212 corresponds to a unique ID associated with a root data node for which the message 200 may be created. The root data node may be further processed by one or more messages, each representing a different transaction. In such a case, the data value for the key attribute of the one or more messages may be identical to the data value of the key 212 associated with the message 200. The identical data value of the key associated with the one or more messages may allow to maintain an order of the one or more messages in a message queue within the topic 210 based on the processing of the one or more messages on the root data node. Further, the key 212 is used to establish a single partition in the message queue of a messaging system (for example, Kafka) such that the one or more messages may be stored and consumed in the exact order in which they were produced. In an embodiment, if the root data node is processed by two different transactions, i.e., by two different messages, the processing order of the two messages may be maintained for one or more handler microservices that may subscribe to these messages. Utilization of the key 212 allows the sending of these messages to the same partition so that the one or more handler microservices may subscribe to these messages from the same partition.

The scope 214 ensures appropriate security of the message 200. Data values of the scope 214 may be internal or external. When the data value of the scope 214 is internal, the message 200 may be internal, e.g., the message 200 may be communicated between one or more microservices associated with a host system. Alternatively, when the data value of the scope 214 is external, the message 200 may be external, e.g., the message 200 may be communicated between a microservice associated with a native system and different microservices associated with an external system. Therefore, the data value of the scope 214 may be one of internal, external, or internal and external.

The access 216 determines access permission to the message 200. In an instance, when a data value of the access 216 is public, a user trying to access the message 200 is not required to be authenticated prior to the access. In another instance, when the data value of the access 216 is private, a user trying to access the message 200 is required to be authenticated prior to accessing the message 200.

The status 218 is indicative of the progress of execution of the message 200. A data value of the status 218 of the message 200 may be one of created, raised, received, handled, or processed.

The execution 220 is indicative of a path that is to be traveled by the message 200 to reach its destination node, The data value of the execution 220 may be synchronous or asynchronous. In an instance, when the data value of the execution 220 is asynchronous, the message 200 may follow a transaction path that is loosely coupled. That is to say, the message 200 generated by a producer microservice may be communicated to a consumer microservice by way of a message-oriented middleware, such as Kafka, RabbitMQ, or the like. In another instance, when the data value of the execution 220 is synchronous, the message 200 may follow a transaction path that is not loosely coupled. For example, in the case of an application using a messaging mechanism, a built-in application programming interface (API) may be utilized that may allow communication of the message 200 within the application without relying on an external message-oriented middleware.

The action 222 is indicative of an action or operation to be performed by a microservice that subscribes to the message 200.

The created-on timestamp 224 includes details (such as time, date, day, month, or the like) regarding the creation of the message 200 by its source microservice.

The raised-on timestamp 226 includes details (such as time, date, day, month, or the like) regarding the publication of the message 200 on a communication bus by its source microservice. The communication bus forms a channel between a source microservice and a destination microservice of the message.

The received-on timestamp 228 includes details (such as time, date, day, month, or the like) regarding when the message 200 was received by the destination microservice but has not been processed.

The handled-on timestamp 230 includes details (such as time, date, day, month, or the like) associated with a point in time when the processing of the message 200 is initiated.

The processed-on timestamp 232 includes details (such as time, date, day, month, or the like) regarding when the processing of the message 200 gets completed.

The publisher ID 234 is a unique ID for a publisher microservice that has published the message 200. A data value of the publisher ID 234 may be associated with the source microservice or an intermediate microservice.

The subscriber ID 236 is a unique ID for a handler microservice(s) that subscribes to the message 200. Notably, a command-type message and a query-type message may be subscribed to by a single microservice, whereas an event-type message may be subscribed to by multiple microservices and each microservice may receive a copy of the event-type message.

The allow retry 238 ensures successful communication and processing of the message 200. A data value of the allow retry 238 determines if the message 200 is to be re-published in case the status of the message 200 is a failure or partial failure. The re-published message may be a clone of the original message 200.

The maximum retry allowed 240 determines the maximum count for which the message 200 is to be re-published in case the status of the message 200 is a failure or a partial failure.

The current retry count 242 keeps track of the number of times for which the message 200 is re-published. That is to say that the current retry count 242 is indicative of a current count of re-publications of the message 200. The data value of the current retry count 242 gets incremented with each re-publication of the message 200.

The retry source ID 244 included in the message 200 is a unique ID of an original message that is being re-published. The retry source ID 244 is required as a clone message with a different ID is generated and published during the re-publication of the message 200. The clone message has timestamps (e.g., created-on timestamp, received-on timestamp, or the like) that are different from the timestamps included in the message 200. Therefore, to link the clone message to the message 200, a data value of the retry source ID 244 is included in the clone message.

The source ID 246 represents an object that initiated the message creation. For example, if a user experience (UX) initiates a transaction, the data value of the source ID 246 may correspond to the data value of an ID of the UX control/page. In another embodiment, the source ID 246 is included in the message 200 if the message 200 has originated from another message. For example, an event-type message that is created in response to the processing of a command-type message may have a data value of the source ID 246 that is identical to the data value of the ID 202 of the command-type message.

The message type 248 is indicative of the message 200 being one of a command message, a query message, or an event message. The message type 248 may further include a flag, where a value ‘1’ of the flag may indicate that the message represented by the message 200 is a leaf message, whereas a value ‘0’ of the flag may indicate that the message 200 is a composite message. The leaf message does not have any sub-messages, whereas the composite message is a message having one or more sub-messages. In other embodiments, composite and leaf messages may be indicated differently without deviating from the scope of the disclosure.

The time to live 250 may be indicative of a time period during which the message 200 may be valid. Therefore, the message should be communicated and processed within a duration that is indicated by a data value of the time to live 250. In an instance of failure or partial failure, the message 200 should not be re-published once the time period indicated by the data value of the time to live 250 has lapsed. Notably, the lapse of the time period indicated by the data value of the time to live 250 is indicative of message 200 being invalid.

The user ID 252 has a corresponding data value that is a unique ID associated with a user of the real-time system 102 that may have generated the message 200.

The source type 254 refers to a source that may have caused the generation of the message 200. In an embodiment, a data value of the source type 254 may be one of command, query, and event. In another embodiment, the data value of the source type 254 may be a non-message type.

The composition of the message 200 described in FIG. 2 may be used by the processing circuitry 104 for performing the analysis of the message. Such analysis may be performed to determine one or more analytical insights related to the performance of the business solution associated with the real-time system 102.

The plurality of attributes associated with the message 200 may include one or more attributes that comprise static information and one or more attributes that comprise dynamic information. The static information may be assigned to the one or more attributes at the time of the creation of the message 200, whereas the dynamic information may be assigned to the one or more attributes during the processing of the message 200. The one or more attributes with static information may correspond to ID 202, the correlation ID 204, the name 206, the category 208, the topic 210, the key 212, the scope 214, the access 216, the execution 220, the action 222, the allow retry 238, the maximum retry allowed 240, the retry source ID 244, the source ID 246, the source type 254, and the user ID 252. Further, the one or more attributes with dynamic information may correspond to the status 218, the created-on timestamp 224, the raised-on timestamp 226, the received-on timestamp 228, the handled-on timestamp 230, the processed-on timestamp 232, the publisher ID 234, the subscriber ID 236, and the current retry count 242.

It will be apparent to a person skilled in the art that the composition of the message 200 described in conjunction with FIG. 2 is non-limiting, and in other embodiments, components included in the message 200 may differ from the components depicted in FIG. 2.

FIG. 3 is a graph 300 illustrating association between message and attribute nodes, consistent with disclosed embodiments of the present disclosure. The graph 300 may correspond to a portion of the directed property graph 110. Referring to FIG. 3, the processing circuitry 104 may be configured to instantiate a message node 302 in the graph 300 that may represent the message 200.

The processing circuitry 104 may be further configured to associate at least one of the plurality of attributes associated with the message 200 as node properties of the message node 302. The node properties of the message node 302 are shown within a dotted box 304 associated with the message node 302. In the example illustrated in FIG. 3, the node properties may include the ID 202, the action 222, the message type 248 (denoted as “MType” in FIG. 3), and the source type 254 (denoted as “SourceType” in FIG. 3). However, other node properties such as the name 206, the category 208, the topic 210, the key 212, the scope 214, the access 216, the status 218, the execution 220, the created-on timestamp 224, the raised-on timestamp 226, the received-on timestamp 228, the handled-on timestamp 230, the processed-on timestamp 232, the publisher ID 234, the subscriber ID 236, the allow retry 238, the maximum retry allowed 240, the current retry count 242, the retry source ID 244, or the source ID 246 may also be associated as the node properties of the message node 302. Data values of the attributes are not shown in FIG. 3 to keep the illustration concise and clear, and should not be considered a limitation of the present disclosure.

The processing circuitry 104 may be further configured to derive a set of shared attributes from the plurality of attributes associated with the message 200 and instantiate a set of attribute nodes 306-316 in the graph 300 representing the set of shared attributes. For the sake of brevity, the set of shared attributes is shown to include the ID 202, the correlation ID 204, the created-on timestamp 224, the received-on timestamp 228, the handled-on timestamp 230, and the user ID 252. However, other attributes (e.g., the raised-on timestamp 226 and the processed-on timestamp 232) may also be included in the set of shared attributes, without deviating from the scope of the present disclosure. The graph 300 may thus include the attribute node 306 that represents the ID 202, the attribute node 308 that represents the correlation ID 204, the attribute node 310 that represents the created-on timestamp 224, the attribute node 312 that represents the received-on timestamp 228, the attribute node 314 that represents the handled-on timestamp 230, and the attribute node 316 that represents the user ID 252.

The processing circuitry 104 may be further configured to determine, based on the plurality of attributes associated with the message 200, a set of attributes for each attribute node. The set of attributes may be linked with a shared attribute represented by the corresponding attribute node. The processing circuitry 104 may be further configured to associate the set of attributes as node properties of the corresponding attribute node. For example, for the attribute node 308 that represents the correlation ID 204, the ID 202, a sub-ID attribute, and a sub-index attribute may be associated as node properties of the attribute node 308. The node properties of the attribute node 308 are shown within a dotted box 318 associated with the attribute node 308 via a dotted line. The sub-ID and the sub-index attributes may be derived from the ID 202, the correlation ID 204, and the source ID 246 of the message 200. For example, if the message 200 represents a source message (e.g., the data value of the source ID 246 is ‘NULL’), the sub-ID attribute may be false. Conversely, if the message 200 is generated based on the processing of another message (e.g., the source ID 246 may indicate a different (source) message, and the correlation ID 204 may be identical to that of the source message), the sub-ID attribute may be true. Further, the hierarchical level at which the message 200 may be generated may be determined based on the value associated with the sub-index attribute. If the sub-index attribute corresponds to ‘0’, the message 200 may represent a parent message. Conversely, if the sub-index attribute corresponds to ‘1’, the message 200 may represent a first sub-message. Based on the node properties illustrated in FIG. 3, it can be determined that the message node 302 represents a root message as the sub-ID attribute is false (‘F’) and the sub-index attribute is ‘0’.

The processing circuitry 104 may be further configured to create a set of edges between the message node 302 and the attribute nodes 306-316. For example, the processing circuitry 104 may be configured to create an edge 320 between the message node 302 and the attribute node 308 that represents the correlation ID 204. In an example, the edge 320 may be named as message_correlation ID, where the message may correspond to the message node 302 and the correlation ID may correspond to the correlation ID 204 represented by the attribute node 308. The edge 320 may couple the message node 302 to the attribute node 308 by way of an out-role and an in-role. The out-role may define an origin, for example, the message node 302 of the edge 320, and the in-role may define a destination, for example, the attribute node 308 of the edge 320.

The processing circuitry 104 may be further configured to determine, for each edge, based on the plurality of attributes associated with the message 200, a set of edge attributes that is indicative of an association between the message node 302 and the corresponding attribute node. The set of edge attributes may include at least one attribute associated as the node properties of the message node 302 and at least one of the set of attributes associated as the node properties of the corresponding attribute node. Further, the processing circuitry 104 may be configured to associate the set of edge attributes as edge properties of the corresponding edge. In an example, the edge properties associated with the edge 320 may include the message ID (e.g., the ID 202), the message type 248, the correlation ID 204, the sub-ID attribute, and the sub-index attribute. The edge properties associated with the edge 320 are illustrated in a dotted box 322 in the form of a key-value pair. In an embodiment, where the message node 302 may represent a root message of command type and have an ID as ‘C1’, the edge properties associated with the edge 320 may include the values ‘C1’, ‘CMD’, ‘A0’, ‘F’, and ‘0’ for the message ID (denoted as “MID” in FIG. 3), the message type 248, the correlation ID 204 (denoted as “CrID” in FIG. 3), the sub-ID attribute, and the sub-index attribute, respectively. Similarly, edges 324-332 may couple the message node 302 to the attribute nodes 306, 310, 312, 314, and 316, respectively. The edges 324-332 may store the edge properties in a similar manner as described above.

In numerous embodiments, an attribute node may represent composite data. For example, the attribute node 310 that represents the created-on timestamp 224 may store composite data (e.g., a combination of year, month, and day). In such a scenario, attribute nodes 334-338 may be instantiated to represent year, month, and day values, respectively. Further, edges 340-344 may couple the attribute node 310 to the attribute nodes 334-338, respectively. The attribute nodes 334-338 and the edges 340-344 may be implemented in a similar manner as described above. The attribute nodes 312 and 314 may also represent composite data and additional attribute nodes and edges may be implemented for the attribute nodes 312 and 314 in a similar manner as described above.

In the real-time system 102, real-world objects such as people (e.g., users or employees), places (e.g., buildings or geographic coordinates), devices (e.g., sensors or mobile phones), or the like, may be denoted as entities. Actions involving these entities (e.g., the action 222 of the message 200) like updating data, initiating specific tasks, or facilitating data exchange, may be carried out by one or more messages associated with the real-time system 102.

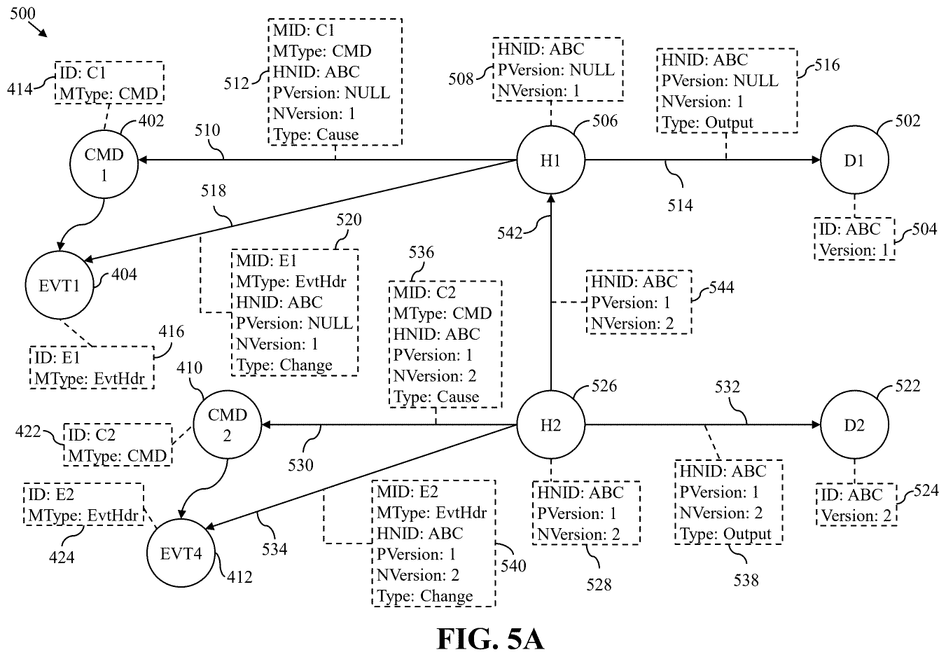

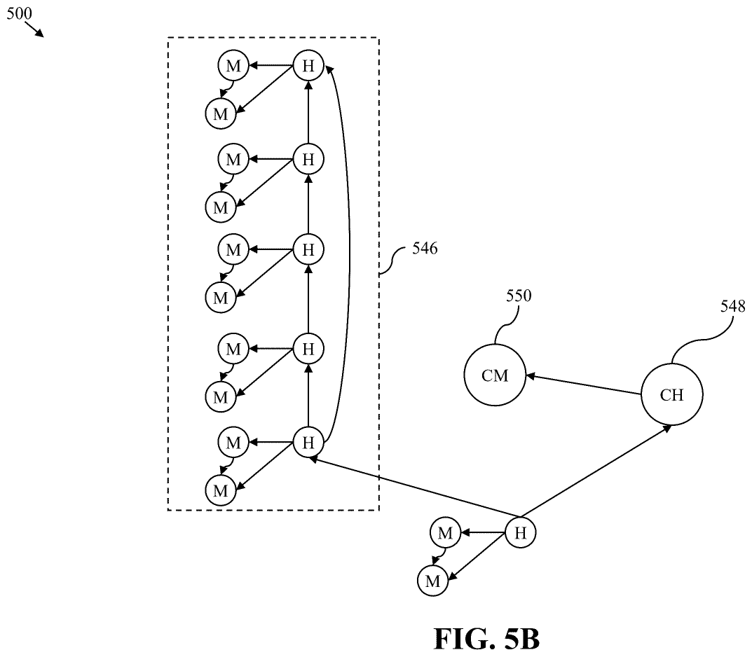

The processing circuitry 104 may be further configured to instantiate an entity node 346 (e.g., a data node) associated with the message node 302. The entity node 346 may represent an entity associated with the real-time system 102. Further, the processing circuitry 104 may be configured to create an edge 348 between the message node 302 and the entity node 346. The processing circuitry 104 may be further configured to determine the set of edge attributes for the edge 348 and associate the set of edge attributes as edge properties of the edge 348 in a similar manner as described above. In such a scenario, the set of edge attributes may be indicative of an association between the message node 302 and the entity node 346. The entity node 346 may represent a target object on which the action 222 of the message 200 may be executed by the user associated with the real-time system 102. This association is shown in FIG. 3 by way of an edge 350 that couples the attribute node 316, that represents the user ID 252, to the entity node 346. The entity nodes are explained in detail in conjunction with FIGS. 5A and 5B.

Other messages and compositions thereof may be created in the directed property graph 110 in a similar manner as described above. However, for a unique data value associated with an attribute, exclusively one attribute node is instantiated. That is to say, one or more message nodes, having the same data value for the attribute created as an attribute node, may be associated with the same attribute node. In other words, any of the attribute nodes 306-316 and 334-338 may be shared between multiple message nodes.

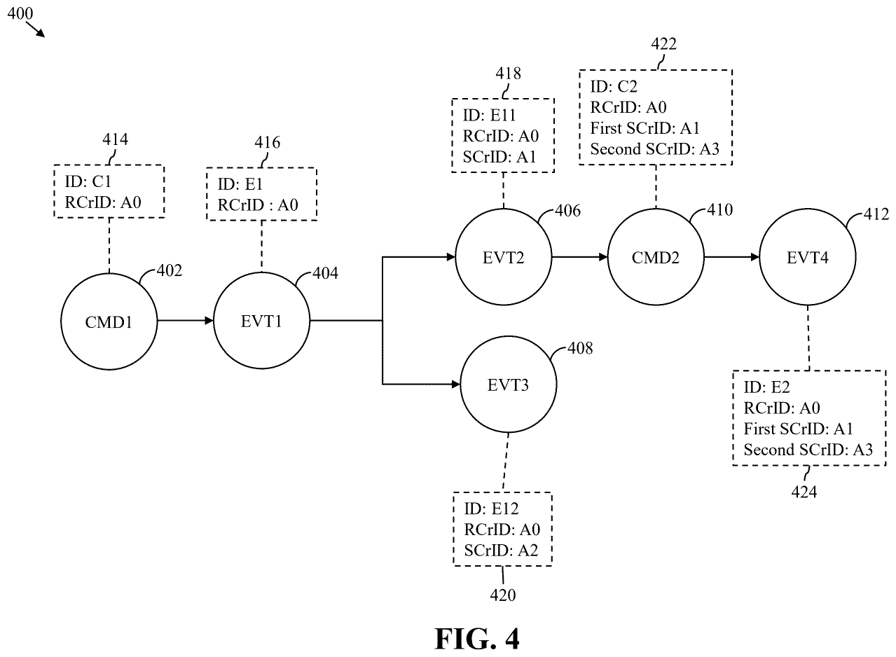

FIG. 4 is a graph 400 illustrating a compact view of correlation between message nodes, consistent with disclosed embodiments of the present disclosure. The graph 400 may correspond to a portion of the directed property graph 110. Various messages of the real-time system 102 may be correlated (e.g., various messages of the real-time system 102 may be a causal association therebetween). In an example, a first command message, a first event message, a second event message, a third event message, a second command message, and a fourth event may be correlated.

Referring to FIG. 4, the processing circuitry 104 may be configured to instantiate message nodes 402-412 in the graph 400 that may represent the first command message, the first event message, the second event message, the third event message, the second command message, and the fourth event message, respectively. In an embodiment, the processing circuitry 104 may be further configured to associate at least one attribute with each of the message nodes 402-412 as node properties thereof. Some of the node properties associated with the message nodes 402-412 are illustrated in dotted boxes 414-424, respectively.

The message node 402 may be associated with an ID ‘C1’ and a root correlation ID ‘A0’. The ID ‘C1’ is unique and is used to identify the message node 402. The root correlation ID (denoted as “RCrID” in FIG. 4) is indicative of a transactional operation associated with the root message (e.g., the first command message) for executing a first transaction in the real-time system 102 by a microservice associated therewith. Similarly, the message node 404 may be associated with an ID ‘E1’ and the root correlation ID ‘A0’. The message ID ‘E1’ is unique and is used to identify the message node 404. The association of the root correlation ID ‘A0’ with the message node 404 is indicative of a causal association between the message nodes 402 and 404. The term causal association is indicative of one message being generated based on the processing of another message. That is to say that the first event message is generated based on the processing of the first command message. Thus, the first command message is correlated with the first event message such that the first command message has a causal association with the first event message, and as a result, the message node 402 representing the first command message has a causal association with the message node 404 representing the first event message. The processing circuitry 104 may be further configured to create an edge between the message nodes 402 and 404 to indicate the association between them. The message node 402 may thus be a parent message node to the message node 404. The association of the root correlation ID ‘A0’ with the message node 404 is further indicative of the first event message being generated as a part of the execution of the first transaction associated with the message node 402.

Similarly, the second and third event messages may be generated based on the processing of the first event message. The second and third event messages may be clone event messages of the first event message. The second and third event messages may be generated based on the subscription of the first event message by two subscribers (e.g., microservices). The message nodes 406 and 408 may thus represent the clones of the message node 404. Thus, the processing circuitry 104 may be configured to create an edge between the message nodes 404 and 406, and another edge between the message nodes 404 and 408.

As illustrated in FIG. 4, the message node 406 may be associated with an ID ‘E11’, the root correlation ID ‘A0’, and a sub-correlation ID ‘A1’. Similarly, the message node 408 may be associated with an ID ‘E12’, the root correlation ID ‘A0’, and a sub-correlation ID ‘A2’. The association of the root correlation ID with the message nodes 406 and 408 indicates that the second and third event messages are generated as a part of the execution of the first transaction and that each of the message nodes 406 and 408 are child message nodes to the message nodes 402 and 404. The different sub-correlation IDs (denoted as “SCrID” in FIG. 4) indicate distinct transactional operations associated with the two event messages (e.g., the second and third event messages). The association of the sub-correlation ID ‘A1’ with the message node 406 is indicative of a second transaction that is different from the first transaction. Further, the association of both the root correlation ID ‘A0’ and the sub-correlation ID ‘A1’ with the message node 406 is indicative of the second transaction being a sub-transaction to the first transaction. Similarly, the association of the sub-correlation ID ‘A2’ with the message node 408 is indicative of a third transaction that is different from but a sub-transaction to the first transaction. The message node 404 does not have a sub-correlation ID associated therewith as the first event message and the first command message are part of the same logical transaction.

The second command message may be generated based on the processing of the second event message. Thus, the processing circuitry 104 may be configured to create an edge between the message nodes 406 and 410. The message node 410 may be associated with an ID ‘C2’, the root correlation ID ‘A0’, a first sub-correlation ID ‘A1’, and a second sub-correlation ID ‘A3’. The association of the root correlation ID ‘A0’ and the first sub-correlation ID ‘A1’ with the message node 410 indicates that the second command message is generated as a part of the execution of the first transaction and that the message node 410 is a child message node to the message nodes 402, 404, and 406. The association of the second sub-correlation ID ‘A3’ with the message node 410 is indicative of a fourth transaction that is different from the second transaction. Further, the association of both the first sub-correlation ID ‘A1’ and the second sub-correlation ID ‘A3’ is indicative of the fourth transaction being a sub-transaction to the second transaction.

The message node 412 may be associated with an ID ‘E2’, the root correlation ID ‘A0’, the first sub-correlation ID ‘A2’, and the second sub-correlation ID ‘A3’. The message ID ‘E2’ is unique and is used to identify the message node 412. The association of the root correlation ID ‘A0’, the first sub-correlation ID ‘A2’, and the second sub-correlation ID ‘A3’ with the message node 412 indicates that the fourth event message is generated as a part of the execution of the first transaction and that the message node 412 is a child message node to the message node 402, 404, 406, and 410. The message node 412 does not have a distinct sub-correlation ID associated therewith as the fourth event message and the second command message are part of the same logical transaction. The processing circuitry 104 may be configured to create an edge between the message nodes 410 and 412. The edges are not labeled in FIG. 4 to keep the illustration concise and clear, and should not be considered a limitation of the present disclosure.

The association of a common correlation ID (e.g., the root correlation ID ‘A0’) with two or more message nodes is indicative of a causal association therebetween. Further, the association of a new correlation ID (e.g., the sub-correlation IDs ‘A1’, ‘A2’, and ‘A3’) is indicative of a new transaction being initiated based on message processing. Although not shown, each of the message nodes 402-412 may be associated with the same user ID, which indicates that the message nodes 402-412 are associated with the same user.

The graph 400 may enable optimized query processing. For example, the processing circuitry 104 may receive a query indicative of an analysis to be performed for the first command message. For such an analysis, all the messages correlated to the first command message may be required. In such an embodiment, the processing circuitry 104 may be configured to identify the message nodes 404-412 that are correlated to the message node 402 based on the root correlation ID ‘A0’ and generate a response to the query based on the message nodes 402-412. The association of the common correlation ID results in optimized tracking of the correlated message nodes.

In FIG. 4, the correlated message nodes 402-412 are illustrated in the compact form. That is to say that compositions associated therewith are not shown in FIG. 4. While performing analytics on any message node, message compositions may be required, and hence, it is important to understand the structure of the compositions of correlated messages in the directed property graph 110.

FIG. 5A is a graph 500 illustrating the creation, maintenance, and utilization of messaging history, consistent with disclosed embodiments of the present disclosure. The graph 500 may correspond to a portion of the directed property graph 110.

The processing circuitry 104 may be configured to receive a first stimulus from a microservice associated with the real-time system 102. The first stimulus may correspond to the first command message. The processing circuitry 104 may be configured to instantiate the message node 402 representing the first command message. The first command message may have a plurality of attributes associated therewith. The processing circuitry 104 may be further configured to associate at least one attribute of the first command message as node properties of the message node 402. The dotted box 414 is shown to include some of the node properties of the message node 402 in the form of key-value pairs such as ID: ‘C1’ and message type (denoted as “Mtype” in FIG. 5A): ‘CMD’.

The first command message may be associated with an operation indicative of a data node creation in the graph 500. In other words, the first command message may comprise details required to create a data node. Thus, based on the processing of the first command message, the processing circuitry 104 may be further configured to create a data node 502. In other words, the data node 502 is generated based on an execution of the first command message. The processing circuitry 104 may be further configured to determine a set of attributes for the data node 502 and associate the set of attributes as node properties of the data node 502. Some of the node properties of the data node 502 are illustrated in a dotted box 504. The dotted box 504 is shown to include some of the attributes in the form of key-value pairs such as data node ID (denoted as “ID” in FIG. 5A): ‘ABC’ and data node version number (denoted as “Version” in FIG. 5A): ‘1’. The value of ‘1’ for the data node version number attribute indicates that the data node 502 is a root data node.

The generation of the data node 502 in the graph 500 may correspond to a change event associated with the real-time system 102. This change may be captured by the processing circuitry 104 in the form of the first event message. Therefore, the first event message may be indicative of the generation of the data node 502 and may comprise data and transactional information associated with the data node 502. The processing circuitry 104 may be further configured to instantiate the message node 404 to represent the first event message. The first event message may have a plurality of attributes associated therewith. The processing circuitry 104 may be further configured to associate at least one attribute of the first event message as node properties of the message node 404. The dotted box 416 is shown to include some of the node properties of the message node 404 in the form of key-value pairs such as ID: ‘E1’ and type: ‘Event Header’ (denoted as “EvtHdr” in FIG. 5A).

Based on the generation of the data node 502, the processing circuitry 104 may be further configured to create a history node 506 that links the message node 402, the message node 404, and the data node 502. The history node 506 links the message node 402, the message node 404, and the data node 502 to indicate that the data node 502 is an output associated with the processing of the first command message represented by the message node 402 and the message node 404, that represents the first event message, stores a change associated with the data node 502. The processing circuitry 104 may be further configured to determine a set of attributes for the history node 506 and associate the set of attributes as node properties of the history node 506. Some of the node properties of the history node 506 are illustrated in a dotted box 508. The dotted box 508 is shown to include some of the attributes in the form of key-value pairs such as history node identifier (denoted as “HNID” in FIG. 5A): ‘ABC’, a previous data node version (denoted as “Pversion” in FIG. 5A): ‘NULL’, and a next data node version number (denoted as “Nversion” in FIG. 5A): ‘1’. The data value ‘NULL’ of the previous data node version number attribute and the data value ‘1’ of the next data node version number attribute may indicate that the data node 502 is a root data node. The inclusion of ‘ABC’ as the history node ID indicates that the history node 506 tracks the history of the data node 502 having the ID ‘ABC’.

The history node 506 may link the message node 402, the message node 404, and the data node 502 by way of edges. For example, the processing circuitry 104 may be further configured to create a history-message edge 510 between the history node 506 and the message node 402. The history-message edge 510 may indicate that the first command message represented by the message node 402 is a cause for the generation of the data node 502. Further, the processing circuitry 104 may be configured to determine a set of edge attributes for the history-message edge 510 and associate the determined set of edge attributes as edge properties thereof. In an embodiment, the set of edge attributes may include a type attribute. In other words, the processing circuitry 104 may be configured to determine a type attribute for the history-message edge 510 and associate the type attribute as the edge properties thereof. As the history-message edge 510 is indicative of the cause of the generation of the data node 502, the data value of the attribute type may correspond to cause. The set of edge attributes of the history-message edge 510 may also include at least one attribute associated as the node properties of the history node 506 and at least one attribute associated as the node properties of the message node 402. The edge properties of the history-message edge 510 are illustrated in a dotted box 512. The dotted box 512 is shown to include some of the edge attributes in the form of key-value pairs such as message ID (denoted as “MID” in FIG. 5A): ‘C1’, Mtype: ‘CMD’, HNID: ‘ABC’, Pversion: ‘NULL’, Nversion: ‘1’, and Type: ‘Cause’.

Similarly, the processing circuitry 104 may be further configured to create a history-data edge 514 between the history node 506 and the data node 502. The history-data edge 514 may indicate that the data node 502 is an output associated with the processing of the first command message. Further, the processing circuitry 104 may be configured to determine a set of edge attributes for the history-data edge 514 and associate the determined set of edge attributes as edge properties thereof. In an embodiment, the set of edge attributes may include a type attribute. In other words, the processing circuitry 104 may be configured to determine a type attribute for the history-data edge 514 and associate the type attribute as the edge properties thereof. As the history-data edge 514 is indicative of the output of the processing of the first command message, the data value of the attribute type may correspond to output. The set of edge attributes of the history-data edge 514 may also include at least one attribute associated as the node properties of the history node 506 and at least one attribute associated as the node properties of the data node 502. The edge properties of the history-data edge 514 are illustrated in a dotted box 516. The dotted box 516 is shown to include some of the edge attributes in the form of key-value pairs such as HNID: ‘ABC’, Pversion: ‘NULL’, Nversion: ‘1’, and Type: ‘Output’.

Further, the processing circuitry 104 may be configured to create a history-message edge 518 between the history node 506 and the message node 404. The history-message edge 518 may indicate a change associated with the data node 502. Further, the processing circuitry 104 may be configured to determine a set of edge attributes for the history-message edge 518 and associate the determined set of edge attributes as edge properties thereof. In an embodiment, the set of edge attributes may include a type attribute. In other words, the processing circuitry 104 may be configured to determine a type attribute for the history-message edge 518 and associate the type attribute as the edge properties thereof. As the history-message edge 518 is indicative of the change associated with the data node 502, the data value of the attribute type may correspond to change. The set of edge attributes of the history-message edge 518 may also include at least one attribute associated as the node properties of the history node 506 and at least one attribute associated as the node properties of the message node 404. The edge properties of the history-message edge 518 are illustrated in a dotted box 520. The dotted box 520 is shown to include some of the edge attributes in the form of key-value pairs such as MID: ‘E1’, Mtype: ‘EvtHdr’, HNID: ‘ABC’, Pversion: ‘NULL’, Nversion: ‘1’, and Type: ‘Change’.

The processing circuitry 104 may be further configured to receive a second stimulus indicative of a modification of the data node 502. The second stimulus may be associated with the data value ‘ABC’ of the ID of the data node 502. In an embodiment, the second stimulus may correspond to the second command message. The change associated with the data node 502 captured by the first event message may be later subscribed to by one or more microservices associated with the real-time system 102. As explained above in FIG. 4, the first event message may correspond to the event header of the first command message. Further, the subscription of the first event message may create a clone of the first event message (e.g., the second event message) and the one or more microservices may further execute one or more operations based on the handling of the cloned event message. For example, the second command message may be generated based on the handling of the second event message.

The processing circuitry 104 may be configured to instantiate the message node 410 that may represent the second command message. The second command message may have a plurality of attributes associated therewith. The processing circuitry 104 may be further configured to associate at least one attribute with the message node 410 as node properties thereof. The dotted box 422 is shown to include some of the node properties of the message node 410 in the form of key-value pairs such as ID: ‘C2’ and Mtype: ‘CMD’.

The second command message may be associated with an operation indicative of an update of the data node 502. Thus, based on the second command message, the processing circuitry 104 may be further configured to identify the data node 502 in the graph 500. Further, based on the data node 502 and the processing of the second command message, the processing circuitry 104 may be configured to create a data node 522. In other words, the data node 522 is generated based on an execution of the second command message. The data node 502 may correspond to a previous version of the data node 522 such that the data node 502 is modified based on the processing of the second command message to generate the data node 522. The processing circuitry 104 may be further configured to determine a set of attributes for the data node 522 and associate the set of attributes as node properties of the data node 522. Some of the node properties of the data node 522 are illustrated in a dotted box 524. The dotted box 524 is shown to include some of the attributes in the form of key-value pairs such as data node ID: ‘ABC’ and data node version number: ‘2’. The value of ‘2’ for the data node version number attribute indicates that the data node 522 is a next version of the data node 502.

The generation of the data node 522 in the graph 500 may correspond to a change event associated with the real-time system 102. This change may be captured by the processing circuitry 104 in the form of the fourth event message. Therefore, the fourth event message may be indicative of the generation of the data node 522 and may comprise data and transactional information associated with the data node 522. The processing circuitry 104 may be further configured to instantiate the message node 412 to represent the fourth event message. The processing circuitry 104 may be further configured to associate at least one attribute of the fourth event message as node properties of the message node 412. The dotted box 424 is shown to include some of the node properties of the message node 412 in the form of key-value pairs such as ID: ‘E2’ and type: ‘EvtHdr’.

Based on the generation of the data node 522, the processing circuitry 104 may be further configured to create a history node 526 that links the message node 410, the message node 412, and the data node 522. The processing circuitry 104 may be further configured to determine a set of attributes for the history node 526 and associate the set of attributes as node properties of the history node 526. Some of the node properties of the history node 526 are illustrated in a dotted box 528. The dotted box 528 is shown to include some of the attributes in the form of key-value pairs such as HNID: ‘ABC’, Pversion: ‘1’, and Nversion: ‘2’.

The history node 526 may link the message node 410, the message node 412, and the data node 522 by way of edges in a similar manner as described above for the history node 506. Thus, the processing circuitry 104 may be further configured to create a history-message edge 530 between the history node 526 and the message node 410, a history-data edge 532 between the history node 526 and the data node 522, and a history-message edge 534 between the history node 526 and the message node 412. The history-message edge 530 may indicate that the second command message represented by the message node 410 is a cause for the generation of the data node 522. The history-data edge 532 may indicate that the data node 522 is an output associated with the processing of the second command message. Further, the history-message edge 534 may indicate a change associated with the data node 522.

The processing circuitry 104 may be configured to determine a set of edge attributes for each of the history-message edge 530, the history-data edge 532, and the history-message edge 534, and associate the determined set of edge attributes as edge properties thereof in a similar manner as described above. The edge properties of the history-message edge 530, the history-data edge 532, and the history-message edge 534 are illustrated in dotted boxes 536-540, respectively. The dotted box 536 is shown to include some of the edge attributes of the history-message edge 530 in the form of key-value pairs such as MID: ‘C2’, Mtype: ‘CMD’, HNID: ‘ABC’, Pversion: ‘1’, Nversion: ‘2’, and Type: ‘Cause’. The dotted box 538 is shown to include some of the edge attributes of the history-data edge 532 in the form of key-value pairs such as HNID: ‘ABC’, Pversion: ‘1’, Nversion: ‘2’, and Type: ‘Output’. The dotted box 540 is shown to include some of the edge attributes of the history-message edge 534 in the form of key-value pairs such as MID: ‘E2’, Mtype: ‘EvtHdr’, HNID: ‘ABC’, Pversion: ‘1’, Nversion: ‘2’, and Type: ‘Change’.

The processing circuitry 104 may be further configured to link the two history nodes (e.g., the history nodes 506 and 526). For example, the processing circuitry 104 may be further configured to create a history edge 542 between the history node 526 and the history node 506. For the history edge 542, the processing circuitry 104 may be further configured to determine a set of edge attributes that is indicative of an association between the history node 526 and the history node 506, and associate the determined set of edge attributes as edge properties thereof. The edge properties of the history edge 542 may include at least one attribute associated as the node properties of the history node 526 and at least one attribute associated as the node properties of the history node 506. For example, the edge properties of the history edge 542 may include at least one of a group consisting of the history node identifier, the previous data node version number, or the next data node version number. The edge properties of the history edge 542 are illustrated in a dotted box 544. The dotted box 544 is shown to include some of the edge attributes in the form of key-value pairs such as HNID: ‘ABC’, Pversion: ‘1’, and Nversion: ‘2’.

The graph 500 facilitates response generation for a query associated with a system comprising the processing circuitry 104 and the storage element 106. The structure of the graph 500, especially the linking of data, history, and message nodes, enables optimized query processing. In such a graph 500, a response to a query may be generated based on at least one of a group consisting of the message nodes (e.g., the message nodes 402, 404, 410, and 412), the node properties of each message node, the data nodes (e.g., the data nodes 502 and 522), the node properties of each data node, the history nodes (e.g., the history nodes 506 and 526), the node properties of each history node, the edges (e.g., the history-message edges 510, 518, 530, 534, the history-data edges 514 and 532, and the history edge 542), or the edge properties of each edge.

### Query Processing

In an embodiment, the processing circuitry 104 may receive a query. The query may include a reference value. The processing circuitry 104 may be configured to identify, in the graph 500, at least one history node having a data value that is associated with the reference value. Further, the processing circuitry 104 may be configured to identify one or more edges associated with the identified history node. In such a scenario, the processing circuitry 104 may be further configured to generate a response to the query based on at least one of the identified history node, the identified edges, the node properties of the identified history node, or the edge properties of the identified edges. In some embodiments, the processing circuitry 104 may be further configured to identify one or more nodes linked to the identified edges. Each identified node may correspond to a message node, another history node, or a data node. In such cases, the response may be generated further based on such nodes.

The scope of the present disclosure is not limited to the query processing described above. In another embodiment, the processing circuitry 104 may be configured to identify, in the graph 500, an edge having an edge property that is associated with the reference value included in the query. The processing circuitry 104 may be further configured to generate the response to the query based on the edge properties of the identified edge.

In an example, the query may include the reference value ‘ABC’. In such a scenario, the processing circuitry 104 may identify the history node 506 based on the history node ID ‘ABC’. Further, from the node properties of the history node 506, the processing circuitry 104 may determine the presence of the data node 502 in the graph 500. Particularly, from the data value ‘1’ of the next data node version number attribute, the processing circuitry 104 may determine that the data node 502 is the root data node. Further, the processing circuitry 104 may identify edges (e.g., the history-data edge 514 and the history edge 542) associated with the history node 506. Based on the history-data edge 514, the processing circuitry 104 may obtain the data node 502. Further, based on the edge properties of the history edge 542, particularly, from the data value ‘2’ of the next data node version number attribute, the processing circuitry 104 may determine the presence of another data node 522 in the graph 500. From the history node 506, the processing circuitry 104 may traverse to the history node 526, via the history edge 542, and to the data node 522 via the history-data edge 532. The processing circuitry 104 may thus generate the query response based on the data nodes 502 and 522. Thus, linking the history, data, and message nodes, and utilizing a history edge (e.g., the history edge 542) to link two history nodes may facilitate efficient identification of data nodes and faster query processing.

The structure of the graph 500 enables the deletion of various nodes without losing information. For example, in an embodiment, the processing circuitry 104 may be configured to delete at least one of the data node 502 or the data node 522 from the graph 500. In an embodiment, the data nodes 502 and 522 may be deleted based on a lapse of a predetermined time period after the query response generation. In another embodiment, the data nodes 502 and 522 may be deleted based on a lapse of a predetermined time period after the generation thereof. In such cases, when the deleted data nodes are required for query processing, the processing circuitry 104 may be configured to recreate the deleted data nodes using the history nodes and the message nodes present in the graph 500.

In one example, the query may indicate utilization of a root data node associated with ID ‘ABC’. In such a scenario, based on the query, the processing circuitry 104 may be configured to identify, in the graph 500, the history node 506. The processing circuitry 104 may be configured to determine that the data node 502 associated with the identified history node 506 is absent in the graph 500. In such cases, the processing circuitry 104 may be configured to identify, in the graph 500, based on the identified history node 506, the message node 404 that represents the first event message comprising data and transactional information associated with the data node 502. The message node 404 may be identified based on at least one of the node properties of the history node 506, the history-message edge 518, or the edge properties of the history-message edge 518. Based on the identified message node 404, the processing circuitry 104 may be configured to recreate the data node 502 associated with the identified history node 506. The processing circuitry 104 may be further configured to generate a response to the query based on the recreated data node 502.

In another example, the query may indicate utilization of the version ‘2’ data node associated with ID ‘ABC’. In such a scenario, based on the query, the processing circuitry 104 may be configured to identify, in the graph 500, the history node 526 having a data value that is associated with the reference value of the query. The processing circuitry 104 may be configured to determine that the data node 522 associated with the identified history node 526 is absent in the graph 500. Further, based on the node properties of the identified history node 526, the processing circuitry 104 may be configured to determine that the data node 522 has a previous version. Thus, the processing circuitry 104 may be configured to identify, in the graph 500, based on the identified history node 526, another history node 506 associated with the previous version of the data node 522. The history node 506 may be identified based on the history edge 542. Based on the history node 506, the processing circuitry 104 may be configured to identify, in the graph 500, the message node 404 that represents the first event message comprising data and transactional information associated with the data node 502 (e.g., the previous version of the data node 522). The message node 404 may be identified based on at least one of the node properties of the history node 506, the history-message edge 518, or the edge properties of the history-message edge 518. The processing circuitry 104 may be configured to recreate, based on the message node 404, the data node 502 (e.g., the previous version of the data node 522).

The processing circuitry 104 may be configured to identify, in the graph 500, based on the history node 526, the message node 412 that represents the fourth event message comprising data and transactional information associated with the data node 522. The message node 412 may be identified based on at least one of the node properties of the history node 526, the history-message edge 534, or the edge properties of the history-message edge 534. Based on the message node 412 and the data node 502, the processing circuitry 104 may be configured to recreate the data node 522. The data node 502 may be modified based on the fourth event message to recreate the data node 522. The processing circuitry 104 may be configured to generate a response to the query based on the recreated data node 522.

Thus, the data nodes may not be required to be consistently persisted in the graph 500, resulting in optimized memory utilization. In numerous embodiments, the processing circuitry 104 may be configured to delete the recreated data nodes 502 and 522 from the graph 500. Notably, the availability of the event messages represented in the form of message nodes may allow the safe deletion of the data nodes. Additionally, the message nodes may occupy less space than the data nodes, further leading to optimized utilization of the memory resources.

Additionally, in some scenarios, the earliest historical data may not be required for the generation of real-time responses. In the present disclosure, the processing circuitry 104 may be configured to delete the history nodes (e.g., the history nodes 506 and 526) from the graph 500 based on at least one of a history depth or a history retention period associated with the graph 500. The history depth may indicate a maximum number of history nodes associated with one message trail, and the history retention period may indicate a maximum time duration for which each history node is retained in the graph 500.

The graph structure of the present disclosure may thus aid in efficient data retrieval, improved resource utilization, and faster query processing.

The scope of the present disclosure is not limited to the second command message being part of the same message trail that includes the first command message and the first event message. In several embodiments, the second command message may be a standalone message derived from a different stimulus of the real-time system 102.

Although it is described that the data nodes are generated based on the processing of command messages, the scope of the present disclosure is not limited to it. In numerous embodiments, the stimulus may be an event and the data node (e.g., the data nodes 502 and 522) may be generated based on a handling of the event.

The scope of the present disclosure is not limited to the query processing starting from the history node or edge. In some embodiments, the reference value of the query may indicate an attribute (e.g., the correlation ID). In such a scenario, an attribute node having a data value that is identical to the reference value may be identified. Further, based on the edges associated with the identified attribute node, various message nodes may be identified. Once the message nodes are identified, the history-message edges may enable identification of the history nodes.

The third event message that is generated based on the processing of the second event message is not shown in FIG. 5A to keep the illustration concise and clear and should not be considered a limitation of the present disclosure.

In FIG. 5A, the data node 502 is illustrated as a root data node. The scope of the present disclosure is not limited to it. In numerous embodiments, the data node 502 may have a previous version associated therewith. In such a scenario, the processing circuitry 104 may be further configured to identify, in the graph 500, another data node (not shown) that corresponds to a previous version of the data node 502. The other data node may be modified based on the processing of the first command message to generate the data node 502.

Other data nodes and associated message and history nodes may be created in the graph 500 in a similar manner as described above. In such a structure, history edges may couple one history node to a previous history node (e.g., a history node associated with a previous version of the data node), intermediate history nodes, or the root history node (e.g., the history node 506). The creation of the history edges in such a manner may allow faster traversal to the required history node. Beneficially, such traversal is performed in a manner that is optimal and significantly reduces the time and processing complexity associated with the identification of the required data nodes. Further, during the recreation of data nodes, the root data node may be recreated first, followed by the recreation of each subsequent data node using the recreated previous data node and history and message nodes associated with the current data node.

In some embodiments, as the number of data, history, and message nodes increases, a portion of the graph 500 may be snapshotted. In such cases, the processing circuitry 104 may be configured to create a collated history node based on a set of history nodes. The set of history nodes may be contiguous history nodes included in the portion of the graph that is to be snapshotted. Further, the processing circuitry 104 may be configured to create a collated message node for the collated history node based on the message nodes associated with the set of history nodes. The collated message node may include data and transactional information required to recreate the data node version associated with the latest history node of the set of history nodes. Further, the collated history node may be coupled to a history node that is subsequent to the latest history node by way of a history edge. For example, the snapshot may be created for the data nodes 502 and 522. In such a scenario, the collated message node may include data and transactional information required to recreate the data node 522 and the collated history node may be coupled to a third history node (not shown) by way of a history edge. Such snapshotting may limit the number of traversals required for query processing. Another example of snapshotting is shown in FIG. 5B.

FIG. 5B illustrates snapshotting in the graph 500, consistent with disclosed embodiments of the present disclosure. As illustrated in FIG. 5B, the graph 500 may include a portion 546 including various message and history nodes. It is assumed that the data nodes are deleted from the graph 500. The message and history nodes are denoted by “M” and “H”, respectively, in FIG. 5B. In the example shown in FIG. 5B, the portion 546 includes five historical versions. Further, the fifth history node is coupled to a sixth history node having associated message nodes. Additionally, edges may be created between various history nodes for ease of traversal. In FIG. 5B, one such edge is shown between the first and fifth history nodes. Similar edges can be created between the first and sixth history nodes, the fifth and third history nodes, and so on.

In such a scenario, the processing circuitry 104 may be configured to create a collated history node 548 based on the five history nodes included in the portion 546 that is to be snapshotted. Further, the processing circuitry 104 may be configured to create a collated message node 550 for the collated history node 548 based on the message nodes associated with the five history nodes. The collated message node 550 may include data and transactional information required to recreate the data node version associated with the fifth history node. Further, the collated history node 548 may be coupled to the sixth history node that is subsequent to the fifth history node by way of a history edge. Such snapshotting may limit the number of traversals required for query processing. In some embodiments, once a snapshot is created for the portion 546, the processing circuitry 104 may be further configured to delete the portion 546 (e.g., the history nodes and the associated message nodes) from the graph 500.

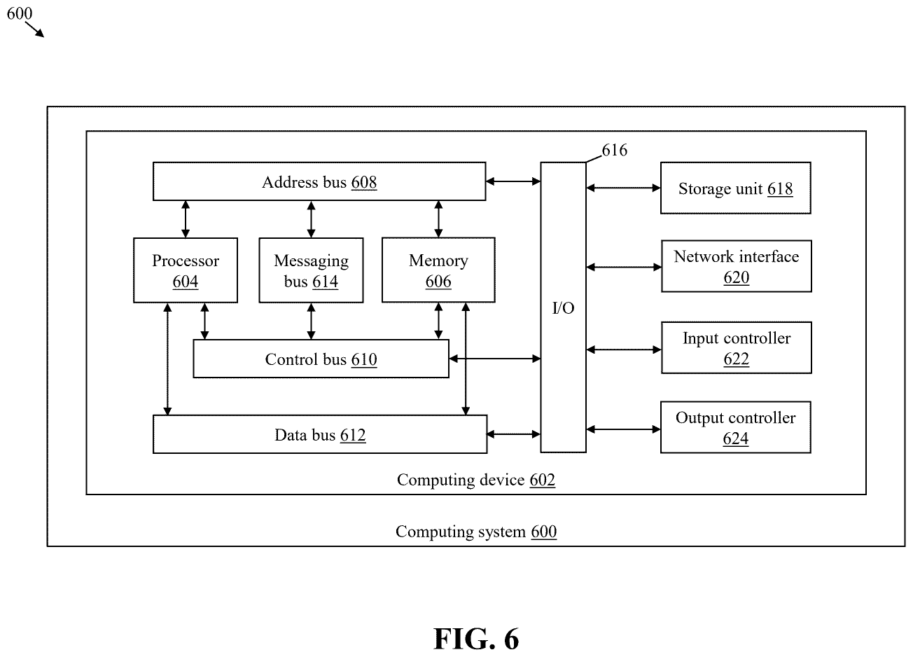

FIG. 6 illustrates an example computing system 600 for carrying out the methods of the present disclosure, consistent with disclosed embodiments of the present disclosure. Specifically, FIG. 6 shows a block diagram of an embodiment of the computing system 600 according to example embodiments of the present disclosure.

The computing system 600 may be configured to perform any of the operations disclosed herein. The computing system 600 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 600 is a distributed system configured to function using multiple computing machines interconnected via a data network or bus system.

The computing system 600 includes computing devices (such as a computing device 602). The computing device 602 includes one or more processors (such as a processor 604) and a memory 606. The processor 604 may be any general-purpose processor(s) configured to execute a set of instructions. For example, the processor 604 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 604 may be multiple processing units, a single processing core, multiple processing cores, special purpose processing cores, co-processors, or any combination thereof. The processor 604 may be communicatively coupled to the memory 606 via an address bus 608, a control bus 610, a data bus 612, and a messaging bus 614.

The memory 606 may include non-volatile memories such as a read-only memory (ROM), a programable read-only memory (PROM), an erasable programmable read-only memory (EPROM), a flash memory, or any other device capable of storing program instructions or data with or without applied power. The memory 606 may also include volatile memories, such as a random-access memory (RAM), a static random-access memory (SRAM), a dynamic random-access memory (DRAM), and a synchronous dynamic random-access memory (SDRAM). The memory 606 may include single or multiple memory modules. While the memory 606 is depicted as part of the computing device 602, a person skilled in the art will recognize that the memory 606 can be separate from the computing device 602.

The memory 606 may store information that can be accessed by the processor 604. For instance, the memory 606 (e.g., one or more non-transitory computer-readable storage mediums, memory devices) may include computer-readable instructions (not shown) that can be executed by the processor 604. The computer-readable instructions may be software written in any suitable programming language or may be implemented in hardware. Additionally, or alternatively, the computer-readable instructions may be executed logically and/or virtually separate threads on the processor 604. For example, the memory 606 may store instructions (not shown) that when executed by the processor 604 cause the processor 604 to perform operations such as any of the operations and functions for which the computing system 600 is configured, as described herein. Additionally, or alternatively, the memory 606 may store data (not shown) that can be obtained, received, accessed, written, manipulated, created, and/or stored. The data can include, for instance, the data and/or information described herein in relation to FIGS. 1-5. In some implementations, the computing device 602 may obtain from and/or store data in one or more memory device(s) that are remote from the computing system 600.

The computing device 602 may further include an input/output (I/O) interface 616 communicatively coupled to the address bus 608, the control bus 610, and the data bus 612. The data bus 612 and messaging bus 614 may include a plurality of tunnels that may support parallel processing of messages. The I/O interface 616 is configured to couple to one or more external devices (e.g., to receive and send data from/to one or more external devices). Such external devices, along with the various internal devices, may also be known as peripheral devices. The I/O interface 616 may include both electrical and physical connections for operably coupling the various peripheral devices to the computing device 602. The I/O interface 616 may be configured to communicate data, addresses, and control signals between the peripheral devices and the computing device 602. The I/O interface 616 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, or the like. The I/O interface 616 is configured to implement only one interface or bus technology. Alternatively, the I/O interface 616 is configured to implement multiple interfaces or bus technologies. The I/O interface 616 may include one or more buffers for buffering transmissions between one or more external devices, internal devices, the computing device 602, or the processor 604. The I/O interface 616 may couple the computing device 602 to various input devices, including mice, touch screens, scanners, biometric readers, electronic digitizers, sensors, receivers, touchpads, trackballs, cameras, microphones, keyboards, any other pointing devices, or any combinations thereof. The I/O interface 616 may couple the computing device 602 to various output devices, including video displays, speakers, printers, projectors, tactile feedback devices, automation control, robotic components, actuators, motors, fans, solenoids, valves, pumps, transmitters, signal emitters, lights, and so forth.

The computing system 600 may further include a storage unit 618, a network interface 620, an input controller 622, and an output controller 624. The storage unit 618, the network interface 620, the input controller 622, and the output controller 624 are communicatively coupled to the central control unit (e.g., the memory 606, the address bus 608, the control bus 610, and the data bus 612) via the I/O interface 616. The network interface 620 communicatively couples the computing system 600 to one or more networks such as wide area networks (WAN), local area networks (LAN), intranets, the Internet, wireless access networks, wired networks, mobile networks, telephone networks, optical networks, or combinations thereof. The network interface 620 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 618 is a computer-readable medium, preferably a non-transitory computer-readable medium, comprising one or more programs, the one or more programs comprising instructions which when executed by the processor 604 cause the computing system 600 to perform the method steps of the present disclosure. Alternatively, the storage unit 618 is a transitory computer-readable medium. The storage unit 618 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 618 stores one or more operating systems, application programs, program modules, data, or any other information. The storage unit 618 is part of the computing device 602. Alternatively, the storage unit 618 is part of one or more other computing machines that are in communication with the computing device 602, such as servers, database servers, cloud storage, network attached storage, and so forth.

The input controller 622 may include suitable logic, circuitry, interfaces, and/or code, executable by the circuitry, that may be configured to control one or more input devices that may be configured to receive an input (e.g., the query) generated by the real-time system 102. The output controller 624 may include suitable logic, circuitry, interfaces, and/or code, executable by the circuitry, that may be configured to control one or more output devices that may be configured to render/output the outcome of the operation executed to process the received input.

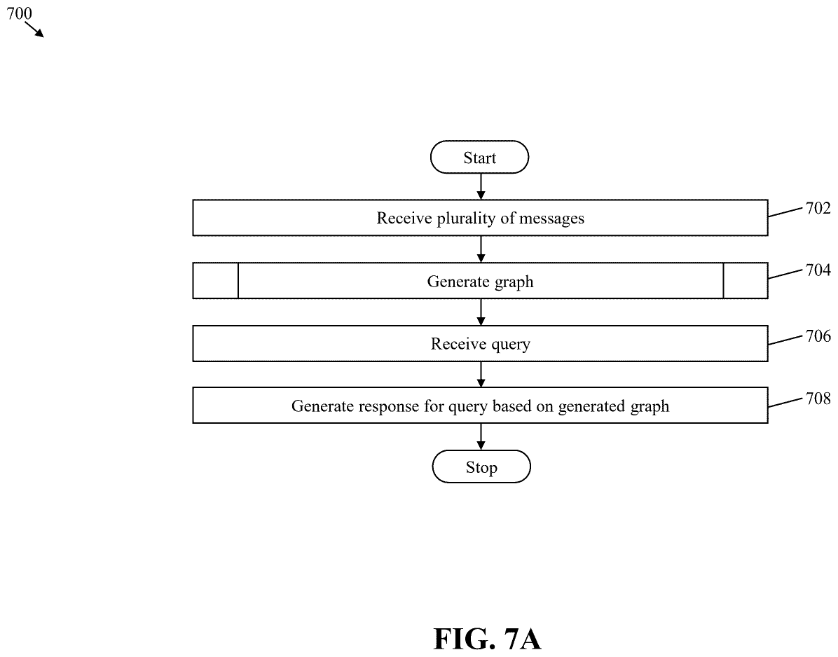

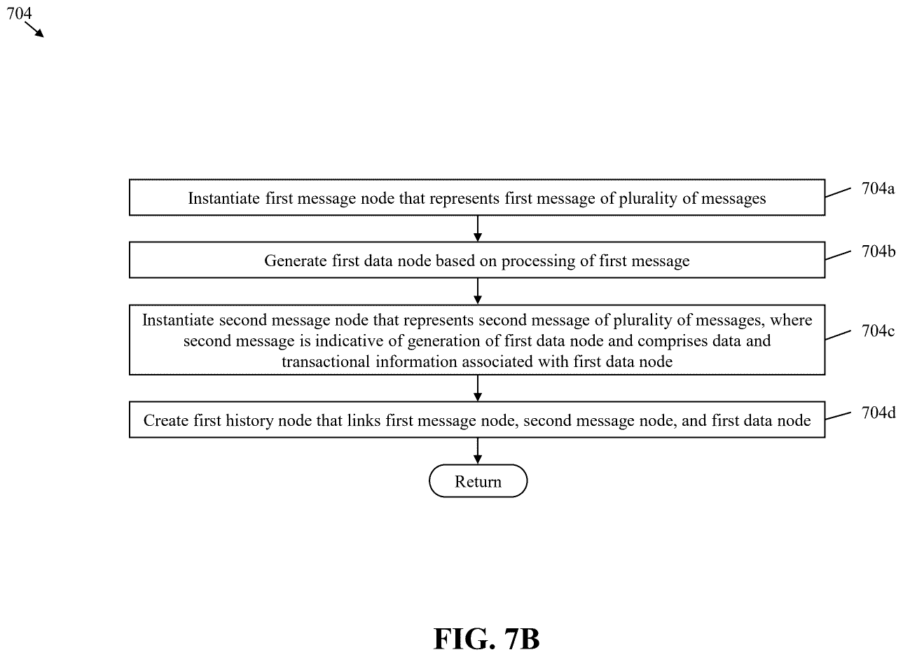

FIGS. 7A and 7B, collectively, represents a flowchart 700 that illustrates a method for facilitating messaging history using directed property graphs, consistent with disclosed embodiments of the present disclosure.

Referring to FIG. 7A, at 702, the processing circuitry 104 may receive a plurality of messages. Each message may be generated within the real-time system 102. At 704, the processing circuitry 104 may generate a graph (e.g., the directed property graph 110). The generation of the graph is explained in conjunction with FIG. 7B.

Referring to FIG. 7B, to generate the graph, at 704a, the processing circuitry 104 may instantiate a first message node that may represent a first message of the plurality of messages. At 704b, the processing circuitry 104 may generate a first data node based on the processing of the first message. At 704c, the processing circuitry 104 may instantiate a second message node that represents a second message of the plurality of messages, where the second message is indicative of the generation of the first data node and may comprise data and transactional information associated with the first data node. At 704d, the processing circuitry 104 may create the first history node that may link the first message node, the second message node, and the first data node. The aforementioned operations may be repeated for the processing of various other messages that may lead to the generation of data nodes.

Referring back to FIG. 7A, at 706, the processing circuitry 104 may receive a query. The query may be generated by the real-time system 102. At 708, the processing circuitry 104 may generate a response for the query based on the generated graph.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for messaging history using directed property graphs. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:
1. A system, comprising:
   processing circuitry configured to generate a graph based on a plurality of messages, wherein to generate the graph, the processing circuitry is further configured to:
      instantiate a first message node that represents a first message of the plurality of messages;
      generate a first data node based on processing of the first message;
      instantiate a second message node that represents a second message of the plurality of messages, wherein the second message is indicative of the generation of the first data node and comprises data and transactional information associated with the first data node; and
      create a first history node that links the first message node, the second message node, and the first data node, and
   wherein the generated graph facilitates query response generation.
2. The system of 1, wherein the first history node links the first message node, the second message node, and the first data node to indicate that (i) the first data node is an output associated with the processing of the first message represented by the first message node and (ii) the second message node, that represents the second message, stores a change associated with the first data node.
3. The system of 1, wherein the first message corresponds to a command, and the first data node is generated based on an execution of the command.
4. The system of 1, wherein the first message corresponds to an event, and the first data node is generated based on a handling of the event.
5. The system of 1, wherein the second message corresponds to an event header.
6. The system of 1, wherein the processing circuitry is further configured to determine a set of attributes for each of the first message node, the first data node, the second message node, and the first history node, and associate the determined set of attributes as node properties thereof.
7. The system of 6,
   wherein the node properties of each of the first message node and the second message node comprise at least one of a group consisting of a message identifier or a message type,
   wherein the node properties of the first data node comprise at least one of a group consisting of a data node identifier or a data node version number, and
   wherein the node properties of the first history node comprise at least one of a group consisting of a history node identifier, a previous data node version number, or a next data node version number.
8. The system of 1, wherein a response to a query is generated based on at least one of a group consisting of (i) the first message node, (ii) node properties of the first message node, (iii) the first history node, (iv) node properties of the first history node, (v) the first data node, (vi) node properties of the first data node, (vii) the second message node, or (viii) node properties of the second message node.
9. The system of 1, wherein the processing circuitry is further configured to create:
   a first history-message edge between the first history node and the first message node, the first history-message edge indicating that the first message represented by the first message node is a cause for the generation of the first data node,
   a first history-data edge between the first history node and the first data node, the first history-data edge indicating that the first data node is an output associated with the processing of the first message, and
   a second history-message edge between the first history node and the second message node, the second history-message edge indicating a change associated with the first data node.
10. The system of 9, wherein for each of the first history-message edge, the first history-data edge, and the second history-message edge, the processing circuitry is further configured to determine a type attribute and associate the type attribute as edge properties thereof, and wherein the type attribute of the first history-message edge, the first history-data edge, and the second history-message edge indicates cause, output, and change, respectively.
11. The system of 9, wherein for each of the first history-message edge, the first history-data edge, and the second history-message edge, the processing circuitry is further configured to determine a set of edge attributes and associate the determined set of edge attributes as edge properties thereof.
12. The system of 11,
   wherein the set of edge attributes of the first history-message edge comprises (i) at least one attribute associated as node properties of the first history node and (ii) at least one attribute associated as node properties of the first message node,
   wherein the set of edge attributes of the first history-data edge comprises (i) at least one attribute associated as the node properties of the first history node and (ii) at least one attribute associated as node properties of the first data node, and
   wherein the set of edge attributes of the second history-message edge comprises (i) at least one attribute associated as the node properties of the first history node and (ii) at least one attribute associated as node properties of the second message node.
13. The system of 9, wherein a response to a query is generated based on at least one of a group consisting of (i) the first history-message edge, (ii) edge properties of the first history-message edge, (iii) the first history-data edge, (iv) edge properties of the first history-data edge, (v) the second history-message edge, or (vi) edge properties of the second history-message edge.
14. The system of 1, wherein the processing circuitry is further configured to delete the first data node from the graph.
15. The system of 1, wherein to generate the graph, the processing circuitry is further configured to:
   instantiate a third message node that represents a third message of the plurality of messages;
   identify, based on the third message, the first data node in the graph;
   generate a second data node based on the first data node and processing of the third message;
   instantiate a fourth message node that represents a fourth message of the plurality of messages, wherein the fourth message is indicative of the generation of the second data node and comprises data and transactional information associated with the second data node; and
   create a second history node that links the third message node, the fourth message node, and the second data node.
16. The system of 15, wherein the first data node corresponds to a previous version of the second data node such that the first data node is modified based on the processing of the third message to generate the second data node.
17. The system of 15, wherein the processing circuitry is further configured to:
   create a history edge between the second history node and the first history node;
   determine, for the history edge, a set of edge attributes that is indicative of an association between the second history node and the first history node, wherein the determined set of attributes comprises at least one of a group consisting of a history node identifier, a previous data node version number, or a next data node version number; and
   associate the set of edge attributes as edge properties of the history edge.
18. The system of 17, wherein a response to a query is generated based on at least one of a group consisting of (i) the third message node, (ii) node properties of the third message node, (iii) the second history node, (iv) node properties of the second history node, (v) the second data node, (vi) node properties of the second data node, (vii) the fourth message node, (viii) node properties of the fourth message node, (ix) the history edge, or (x) the edge properties of the history edge.
19. The system of 15, wherein the processing circuitry is further configured to delete at least one of the first data node or the second data node from the graph.
20. the System of 1,
   wherein the processing circuitry is further configured to delete the first history node from the graph based on at least one of a history depth or a history retention period associated with the graph,
   wherein the history depth indicates a maximum number of history nodes associated with one message trail, and
   wherein the history retention period indicates a maximum time duration for which each history node is retained in the graph.
21. The system of 1, wherein the processing circuitry is further configured to identify, in the graph, a third data node that corresponds to a previous version of the first data node, and wherein the third data node is modified based on the processing of the first message to generate the first data node.
22. The system of 1, wherein the processing circuitry is further configured to:
   receive a query that comprises a reference value;
   identify, in the graph, at least one history node having a data value that is associated with the reference value;
   identify one or more edges associated with the identified history node; and
   generate a response to the query based on the identified history node and the identified one or more edges.
23. The system of 22,
   wherein the processing circuitry is further configured to identify one or more nodes linked to the identified one or more edges, respectively,
   wherein an identified node, of the identified one or more nodes, corresponds to one of a group consisting of a message node, another history node, and a data node, and
   wherein the response is generated further based on the identified one or more nodes.
24. The system of 1, wherein the processing circuitry is further configured to:
   receive a query that comprises a reference value;
   identify, in the graph, at least one edge having an edge property that is associated with the reference value; and
   generate a response to the query based on the identified at least one edge.
25. The system of 1, wherein the processing circuitry is further configured to:
   receive a query that comprises a reference value;
   identify, in the graph, at least one history node having a data value that is associated with the reference value;
   determine that a data node associated with the identified history node is absent in the graph;
   identify, in the graph, based on the identified history node, a message node that represents a message comprising data and transactional information associated with the data node;
   recreate, based on the identified message node, the data node associated with the identified history node; and
   generate a response to the query based on the recreated data node.
26. The system of 1, wherein the processing circuitry is further configured to:
   receive a query that comprises a reference value;
   identify, in the graph, at least one history node having a data value that is associated with the reference value;
   determine that a data node associated with the identified history node is absent in the graph;
   determine, based on node properties of the identified history node, that the data node has a previous version;
   identify, in the graph, based on the identified history node, a previous history node associated with the previous version of the data node;
   identify, in the graph, based on the identified previous history node, a previous message node that represents a previous message comprising data and transactional information associated with the previous version of the data node;
   recreate, based on the identified previous message node, the previous version of the data node;
   identify, in the graph, based on the identified history node, a next message node that represents a next message comprising data and transactional information associated with the data node;
   recreate, based on the identified next message node and the previous version of the data node, the data node associated with the identified history node, wherein the previous version of the data node is modified based on the next message to recreate the data node; and
   generate a response to the query based on the recreated data node.
27. The system of 1, further comprising a storage element, wherein the processing circuitry is coupled to the storage element, and configured to store the graph in the storage element.
28. The system of 1, wherein the graph corresponds to a directed property graph.
29. A method, comprising:
   generating, by processing circuitry, a graph based on a plurality of messages, wherein the step of generating the graph further comprises:
      instantiating, by the processing circuitry, a first message node that represents a first message of the plurality of messages;
      generating, by the processing circuitry, a first data node based on processing of the first message;
      instantiating, by the processing circuitry, a second message node that represents a second message of the plurality of messages, wherein the second message is indicative of the generation of the first data node and comprises data and transactional information associated with the first data node; and
      creating, by the processing circuitry, a first history node that links the first message node, the second message node, and the first data node, and wherein the generated graph facilitates query response generation.

What is claimed is:

1. A system, comprising:
processing circuitry configured to generate a graph based on a plurality of messages,
wherein to generate the graph, the processing circuitry is further configured to:
instantiate a first message node that represents a first message of the plurality of messages;
generate a first data node based on processing of the first message;
instantiate a second message node that represents a second message of the plurality of messages, wherein the second message is indicative of the generation of the first data node and comprises data and transactional information associated with the first data node; and
create a first history node that links the first message node, the second message node, and the first data node, and
wherein the generated graph facilitates query response generation.

2. The system of claim 1, wherein the first history node links the first message node, the second message node, and the first data node to indicate that (i) the first data node is an output associated with the processing of the first message represented by the first message node and (ii) the second message node, that represents the second message, stores a change associated with the first data node.

3. The system of claim 1, wherein the first message corresponds to a command, and the first data node is generated based on an execution of the command.

4. The system of claim 1, wherein the first message corresponds to an event, and the first data node is generated based on a handling of the event.

5. The system of claim 1, wherein the second message corresponds to an event header.

6. The system of claim 1, wherein a response to a query is generated based on at least one of a group consisting of (i) the first message node, (ii) node properties of the first message node, (iii) the first history node, (iv) node properties of the first history node, (v) the first data node, (vi) node properties of the first data node, (vii) the second message node, or (viii) node properties of the second message node.

7. The system of claim 1, wherein the processing circuitry is further configured to create:
a first history-message edge between the first history node and the first message node, the first history-message edge indicating that the first message represented by the first message node is a cause for the generation of the first data node,
a first history-data edge between the first history node and the first data node, the first history-data edge indicating that the first data node is an output associated with the processing of the first message, and
a second history-message edge between the first history node and the second message node, the second history-message edge indicating a change associated with the first data node.

8. The system of claim 7, wherein for each of the first history-message edge, the first history-data edge, and the second history-message edge, the processing circuitry is further configured to determine a type attribute and associate the type attribute as edge properties thereof, and wherein the type attribute of the first history-message edge, the first history-data edge, and the second history-message edge indicates cause, output, and change, respectively.

9. The system of claim 7, wherein a response to a query is generated based on at least one of a group consisting of (i) the first history-message edge, (ii) edge properties of the first history-message edge, (iii) the first history-data edge, (iv) edge properties of the first history-data edge, (v) the second history-message edge, or (vi) edge properties of the second history-message edge.

10. The system of claim 1, wherein the processing circuitry is further configured to delete the first data node from the graph.

11. The system of claim 1, wherein to generate the graph, the processing circuitry is further configured to:
instantiate a third message node that represents a third message of the plurality of messages;
identify, based on the third message, the first data node in the graph;
generate a second data node based on the first data node and processing of the third message;
instantiate a fourth message node that represents a fourth message of the plurality of messages, wherein the fourth message is indicative of the generation of the second data node and comprises data and transactional information associated with the second data node; and
create a second history node that links the third message node, the fourth message node, and the second data node.

12. The system of claim 11, wherein the first data node corresponds to a previous version of the second data node such that the first data node is modified based on the processing of the third message to generate the second data node.

13. The system of claim 11, wherein the processing circuitry is further configured to:
create a history edge between the second history node and the first history node;
determine, for the history edge, a set of edge attributes that is indicative of an association between the second history node and the first history node, wherein the determined set of attributes comprises at least one of a group consisting of a history node identifier, a previous data node version number, or a next data node version number; and
associate the set of edge attributes as edge properties of the history edge.

14. The system of claim 13, wherein a response to a query is generated based on at least one of a group consisting of (i) the third message node, (ii) node properties of the third message node, (iii) the second history node, (iv) node properties of the second history node, (v) the second data node, (vi) node properties of the second data node, (vii) the fourth message node, (viii) node properties of the fourth message node, (ix) the history edge, or (x) the edge properties of the history edge.

15. The system of claim 1,
wherein the processing circuitry is further configured to delete the first history node from the graph based on at least one of a history depth or a history retention period associated with the graph,
wherein the history depth indicates a maximum number of history nodes associated with one message trail, and
wherein the history retention period indicates a maximum time duration for which each history node is retained in the graph.

16. The system of claim 1, wherein the processing circuitry is further configured to identify, in the graph, a third data node that corresponds to a previous version of the first data node, and wherein the third data node is modified based on the processing of the first message to generate the first data node.

17. The system of claim 1, wherein the processing circuitry is further configured to:
receive a query that comprises a reference value;
identify, in the graph, at least one history node having a data value that is associated with the reference value;
identify one or more edges associated with the identified history node; and
generate a response to the query based on at least one of the identified history node and the identified one or more edges.

18. The system of claim 1, wherein the processing circuitry is further configured to:
receive a query that comprises a reference value;
identify, in the graph, at least one history node having a data value that is associated with the reference value;
determine that a data node associated with the identified history node is absent in the graph;
identify, in the graph, based on the identified history node, a message node that represents a message comprising data and transactional information associated with the data node;
recreate, based on the identified message node, the data node associated with the identified history node; and
generate a response to the query based on the recreated data node.

19. The system of claim 1, wherein the processing circuitry is further configured to:
receive a query that comprises a reference value;
identify, in the graph, at least one history node having a data value that is associated with the reference value;
determine that a data node associated with the identified history node is absent in the graph;
determine, based on node properties of the identified history node, that the data node has a previous version;
identify, in the graph, based on the identified history node, a previous history node associated with the previous version of the data node;
identify, in the graph, based on the identified previous history node, a previous message node that represents a previous message comprising data and transactional information associated with the previous version of the data node;
recreate, based on the identified previous message node, the previous version of the data node;
identify, in the graph, based on the identified history node, a next message node that represents a next message comprising data and transactional information associated with the data node;
recreate, based on the identified next message node and the previous version of the data node, the data node associated with the identified history node, wherein the previous version of the data node is modified based on the next message to recreate the data node. and
generate a response to the query based on the recreated data node.

20. A method, comprising:
generating, by processing circuitry, a graph based on a plurality of messages,
wherein the step of generating the graph further comprises:
instantiating, by the processing circuitry, a first message node that represents a first message of the plurality of messages;
generating, by the processing circuitry, a first data node based on processing of the first message;
instantiating, by the processing circuitry, a second message node that represents a second message of the plurality of messages, wherein the second message is indicative of the generation of the first data node and comprises data and transactional information associated with the first data node; and
creating, by the processing circuitry, a first history node that links the first message node, the second message node, and the first data node, and
wherein the generated graph facilitates query response generation.
